(19) United States
(12) Patent Application Publication
(10) Pub. No.: US 2007/0131725 A1
(43) Pub. Date: Jun. 14, 2007

(54) Dispensing valve for fluids stored under pressure

(76) Inventor: Mitchell A. Friedman, Randallstown, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/598,353

(22) Filed: Nov. 13, 2006

Related U.S. Application Data
(60) Provisional application No. 60/735,542, filed on Nov. 10, 2005.

(51) Int. Cl. B67D 3/00

(52) U.S. Cl. 222/518

(57) ABSTRACT

A dispensing valve for fluids stored under pressure is disclosed. A resilient valve actuator is provided at an actuator end of the valve body and operatively connected to a plunger, with the opposite end of the plunger engaging a one-way check assembly that serves to open and close at least one valve port opening. The resilient valve actuator and one-way check assembly are configured to allow ease of dispensing while ensuring a leak-free state is maintained between dispensing operations.

### CROSS REFERENCE TO RELATED APPLICATIONS

This application is based upon and claims benefit of copending and co-owned U.S. Provisional Patent Application Ser. No. 60/735,542 entitled “Dispensing Valve for Fluids Stored Under Pressure”, filed with the U.S. Patent and Trademark Office on Nov. 10, 2005, the specification of which is incorporated herein by reference.

### BACKGROUND OF THE INVENTION

1. Field of the Invention

The present invention generally relates to the field of fluid dispensing apparatus, and more particularly to a dispensing valve assembly for dispensing fluid from a source wherein said fluid is stored under pressurized conditions.

2. Description of the Background

Dispensing valves for dispensing fluid from fluid containers, systems, or other sources of such fluid are shown by U.S. Pat. Nos. 3,187,965; 3,263,875; 3,493,146; 3,620,425; 4,440,316; 4,687,123; and 5,918,779. Such valves can be used, for example, in a system for dispensing beverages or other liquids used by consumers in the home. Low cost, trouble-free, and reliable valve action are significant considerations in these applications. Low cost is particularly important if the valve is to be sold as a disposable item as, for example, where the valve is provided with a filled fluid container and discarded along with the container when the fluid has been consumed.

In U.S. Pat. No. 3,187,965, a dispensing valve for a milk container is shown having a generally integral valve body connected at one end to the milk container. The valve body has an L-shaped passage formed therein defining an inlet opening at one end in communication with the milk container and at the opposite end a discharge outlet for discharging the milk to the exterior of the container. A plunger bore in the valve body provides means for slidably mounting a plunger member. A valve seal fixedly connected to the inner end of the plunger member can be moved by the plunger member to open and close the inlet opening. The opposite or outer end of the plunger member extends to the exterior of the milk container. A push button having a diameter substantially larger than the plunger member is mounted to the outer end of the plunger member and disposed in the valve body so that the push button is exposed for engagement by a user's finger. A compression type spring is engaged between the push button and the valve body. Thus, when a force is exerted against the push button to move the valve seal and open the inlet opening for dispensing milk from the container, the spring at all time exerts a substantial counter force on the push button for returning the valve seal to a closed position. The force exerted by the compression spring tends to increase directly with the inward displacement of the plunger member. Therefore, the user must exert considerable inward force on the push button to hold the valve open.

Another valve, shown in U.S. Pat. No. 3,263,875, uses a similar plunger member and valve body to that of the '965 patent. A resilient diaphragm having a peripheral portion engaged with the valve body acts both as a return spring and as a push button. Unfortunately, commercially available valves having such diaphragmatic actuator members have in the past required the user to exert considerable force to hold the valve open while dispensing the liquid.

Likewise, commercial attempts have been made to provide low-cost dispensing valves for use with disposable containers, but such efforts have met with limited success. For example, Waddington & Duval Ltd. provide a press tap for use with disposable containers (such as wine boxes, water bottles, and liquid laundry detergent containers) under model designations COM 4452 and COM 4458, both of which provide a depressible button actuator operatively connected to a valve closure for moving the valve closure away from a valve seat to dispense fluid. Unfortunately, the valve constructions are configured such that fluid to be dispensed will rest within the dispensing chamber of the valve behind the valve seat after use and thereby outside of any refrigerated or insulated container in which the liquid is stored, thus increasing the risk of spoilage of the volume of fluid resting within the valve body after each use. Moreover, many fluid dispensing applications require vigorous sterilization procedures prior to use of the dispensing equipment, including irradiation at exposures of up to as high as 5.0 MRAD, and high temperature steam and chemical sterilization procedures. The thin-walled polyethylene construction of the valve bodies of the Waddington & Duval dispensing valves cannot withstand such sterilization procedures, and in fact become brittle and prone to failure when exposed to such procedures, thus greatly limiting their use for dispensing food products. Even further, the polyethylene valve closure of the Waddington & Duval dispensing valve construction is highly thermally conductive, such that heat transfer may easily occur between the exterior of the fluid container and the contents of the container simply through the valve structure, again raising the risk of spoilage of the contents.

Similarly, the Jefferson Smurfit Group provides a similar tap for use with disposable containers under the model designation VITOP. Once again, the Jefferson Smurfit Group tap construction is configured such that fluid to be dispensed will rest within the dispensing chamber of the valve behind the valve seat after use and thereby outside of any refrigerated or insulated container in which the liquid is stored, once again increasing the risk of spoilage of the volume of fluid resting within the valve body after each use. Likewise, the thin-walled polypropylene construction of the valve body of the Jefferson Smurfit Group dispensing valve cannot withstand the above-described sterilization procedures, and also becomes brittle and prone to failure when exposed to such procedures, thus greatly limiting their use for dispensing food products. And, as above, the polyester elastomer closure of the Jefferson Smurfit Group dispensing valve construction is highly thermally conductive, such that heat transfer may easily occur between the exterior of the fluid container and the contents of the container simply through the valve structure, again raising the risk of spoilage of the contents.

Thus, although substantial effort has been devoted in the art heretofore towards development of low-cost valves of this general type, there remains an unmet need for a valve which is easier to use and which does not require that the user exert such large forces to hold the valve open. This problem is complicated by the fact that the spring or other resilient member should provide the force necessary to assure leak-free seating of the valve seal when the plunger member is in the closed position. This issue becomes more difficult to address in environments in which the fluid to be dispensed is stored under pressure. Likewise, there remains an unmet need for a disposable valve, which is sufficiently robust so as to be able to withstand vigorous sterilization procedures, which reduces heat transfer through the valve between the interior and exterior of the fluid container, and which does not trap fluid outside of the intended storage vessel between dispensing cycles.

Moreover, for a dispensing valve provided as a component of a throwaway fluid container, it would be highly advantageous to provide an easy to use dispensing valve, which offers the user assurance that the valve has not previously been used or tampered with, and that the integrity of the contents of the fluid container has not been compromised. Unfortunately, the need for such a feature has not been met by prior art dispensing valves.

There is further need for a valve that can be adapted, during manufacture, to provide the desired liquid flow rate for a particular set of conditions such as liquid viscosity and the liquid pressure or “head” available to force the liquid through the valve body. A valve that discharges a thick, high-viscosity fluid such as cold maple syrup or orange juice concentrate at a desirable rate will discharge a low-viscosity fluid such as water or wine under the same pressure at a far higher rate. It would be desirable to provide a valve, which can be fabricated readily using normal production techniques such as injection molding in a range of configurations, having different resistance to fluid flow, to provide for these different conditions. It would be particularly desirable to provide a valve that can be fabricated in these different configurations while with only minor modifications to the molds, and other tools used to make the valve. It would likewise be desirable to provide a valve capable is such easy manufacture and use but that ensured against leakage from the valve, even in environments in which the valve is to be used to dispense fluids stored under pressure.

### SUMMARY OF THE INVENTION

It is, therefore, an object of the present invention to provide a fluid dispensing valve which avoids the disadvantages of the prior art.

It is another object of the present invention to provide a fluid dispensing valve that requires minimal force to maintain the valve in an open position while providing leak-free closure of the valve when seated in a closed position, particularly in environments in which the fluid to be dispensed is stored under pressure.

It is yet another object of the present invention to provide a fluid dispensing valve that may be manufactured in a variety of configurations to allow effective application to fluids of varying viscosities with only minor modifications to manufacturing equipment used to make the valve.

In accordance with the above objects, a dispensing valve for fluids is disclosed which provides for ease of use by requiring only a minimal force exerted on the valve actuator to maintain the valve in an open position, and which offers a simple, ergonomic design and robust functionality capable of dispensing a wide variety of products, and particular fluid products that are stored under pressure.

In a first particularly preferred embodiment, a dispensing valve is provided that is configured for dispensing fluids stored under pressure while maintaining a leak-free state between dispensing operations, the dispensing valve comprising: a first valve body having an actuator end and a fluid inlet end, a connector mechanism proximate the fluid inlet end, a fluid discharge outlet intermediate the actuator end and the fluid inlet end, and a fluid port allowing fluid communication between the fluid inlet end and the fluid discharge outlet; a secondary valve body attached to the first valve body at the connector mechanism, the secondary valve body further comprising a one-way check assembly configured to selectively allow fluid to enter the fluid port and the discharge outlet, the one-way check assembly further comprising a resilient member biasing the check assembly towards a closed position in which fluid is prevented from entering the fluid port and the discharge outlet; and a resilient actuator operatively connected to the one-way check assembly and operatively engaging the first valve body so as to move the one-way check assembly to an open position when the resilient actuator is engaged.

In another particularly preferred embodiment, a dispensing valve is provided that is configured for dispensing fluids stored under pressure while maintaining a leak-free state between dispensing operations, the dispensing valve comprising: a valve body having an actuator end and a fluid inlet end, a fluid discharge outlet intermediate the actuator end and the fluid inlet end, and a fluid port allowing fluid communication between the fluid inlet end and the fluid discharge outlet; a one-way check assembly configured to selectively allow fluid to enter the fluid port and the discharge outlet, the one-way check assembly further comprising a resilient member biasing the check assembly towards a closed position in which fluid is prevented from entering the fluid port and the discharge outlet, the one-way check assembly being further biased towards a closed position by fluid stored within a container to which the dispensing valve is attached; and a resilient actuator operatively connected to the one-way check assembly and operatively engaging the first valve body so as to move the one-way check assembly to an open position when the resilient actuator is engaged.

In a particularly preferred embodiment, the valve body components and actuator are may be formed of a polypropylene copolymer with an average wall thickness of approximately 0.0625 inches. Such dimensional characteristics and materials allow the dispensing valve to withstand the highest aseptic sterilization regimentation as outlined by the Food & Drug Administration (FDA) and maintain the sterility of a product as specified by the National Sanitation Foundation (NSF) guidelines. More specifically, the dispensing apparatus is able to withstand either gamma or cobalt irradiation at the maximum dose of 5.0 MRAD (50 Kilogray) in the first phase of the sterilization process. The dispensing apparatus is then able to withstand the high temperatures associated with the steam and chemical sterilization processes required in the filling process. The dispensing apparatus is capable of withstanding these combined sterilization regimens without degrading the valve structure or operation. Thus, the valve may be used to dispense products ranging from aseptic products (free from microorganisms) including but not limited to dairy, 100% juice and soy products, to commercially sterile products including but not limited to preserved juice and coffee products, to non-sterile fluids such as chemical solvents.

In order to allow a minimal force for holding the valve in an open position, a resilient valve actuator having the characteristics of a nonlinear spring may be provided at an actuator end of the valve body and operatively connected to a plunger, with the opposite end of the plunger engaging a resilient one-way check assembly. An intermediate discharge outlet is positioned between the actuator end and the check assembly, such discharge outlet being placed in fluid communication with the interior of a fluid container to which the valve is attached when the valve is in an open position. A valve port wall is positioned between the check assembly and the discharge outlet providing at least one port for controlling the flow of fluid through the valve body when the valve is in an open position. The valve and the valve port wall are positioned such that when the valve is installed on a liquid container, virtually no liquid will be trapped by the valve structure outside of the insulated container, thus preventing the spoilage of a dose of liquid resting in the valve after each dispensing cycle. A push-button is provided for actuating the dispensing valve and is exposed to the exterior of a fluid container to which the dispensing valve is attached.

The simplicity and functionality of the dispensing valve of the instant invention enables its manufacture and automatic assembly with high cavity tools, which in turn reduces manufacturing costs and offers the market a low cost dispensing solution. The simplicity and functionality of the design also enables the dispensing apparatus to be easily customized in the manufacturing process to fit a wide range of dispensing packages. The dispensing valve of the instant invention is also configured to adapt easily to a wide range of filling machines and filling conditions worldwide.

### BRIEF DESCRIPTION OF THE DRAWINGS

The numerous advantages of the present invention may be better understood by those skilled in the art by reference to the accompanying figures in which:

FIG. 1 is a partial cut-away view illustrating a dispensing valve utilizing a check valve assembly in accordance with an exemplary embodiment of the present invention;

FIG. 2 is cross-sectional view illustrating the dispensing valve of FIG. 1 in a first “closed” position;

FIG. 3 is a cross-sectional view illustrating the dispensing valve of FIG. 1 in a second “open” position;

FIG. 4 is an exploded view of the dispensing valve of FIG. 1;

FIG. 5 is a cross-sectional view illustrating the dispensing valve;

FIG. 6 is a cross-sectional view illustrating the dispensing valve of FIG. 5 in a second “open” position;

FIG. 7A illustrates a top plan view of an actuator utilized with the dispensing valve of FIG. 5;

FIG. 7B is an illustration of a cross-sectional view of a plunger member connected with the actuator utilized with the dispensing valve of FIG. 5;

FIG. 8A is an illustration of a top plan view of an actuator pin utilized with the dispensing valve of FIG. 5;

FIG. 8B is an illustration of side view of the actuator pin of FIG. 8A;

FIG. 9 is an isometric illustration of a cage of a check assembly utilized with the dispensing valve of FIG. 5;

FIG. 10 is a side view illustrating the cage of the check assembly of FIG. 9;

FIG. 11A is a top plan view illustrating the cage of the check assembly of FIG. 9;

FIG. 11B is a cross-sectional view illustrating the cage of the check assembly of FIG. 9;

FIG. 12 is an exploded view of the dispensing valve of FIG. 5;

FIGS. 13A-C are cross-sectional and end views illustrating a dispensing valve utilizing a “duckbill” valve seal member in a first “closed” position in accordance with a second exemplary embodiment of the present invention;

FIGS. 14A-C are cross-sectional and end views illustrating the dispensing valve of FIGS. 13A-C in a second “open” position;

FIG. 15A is a cross-sectional view illustrating the dispensing valve of FIG. 13;

FIG. 15B is a cross-sectional view illustrating a “duckbill” dispensing valve, wherein a duckbill shaped valve seal member is constructed as a cruciform valve seal member;

FIG. 15C is a cross-sectional view illustrating a “duckbill” dispensing valve having an alternate duckbill shaped valve seal member;

FIG. 16A is a cross-sectional view illustrating a dispensing valve utilizing an alternate valve seal member in a first “closed” position in accordance with a third exemplary embodiment of the present invention;

FIG. 16B is a cross-sectional view illustrating the dispensing valve of FIG. 16A in a second “open” position;

FIG. 16C is a cross-sectional view illustrating an actuator connected with a plunger member utilized in the pressure dispensing valve of FIGS. 16A and 16B;

FIG. 16D is a top plan view illustrating a second valve seal utilized by the dispensing valve of FIGS. 16A and 16B;

FIG. 16E is a cross-sectional view illustrating a stiffener disk for use in the dispensing valve of FIGS. 16A and 16B; and

FIG. 16F is a cross-sectional view illustrating a valve body utilized in the pressure dispensing valve of FIGS. 11A and 11B.

### DETAILED DESCRIPTION OF EXEMPLARY EMBODIMENTS

Reference will now be made in detail to the presently preferred embodiments of the invention, examples of which are illustrated in the accompanying drawings.

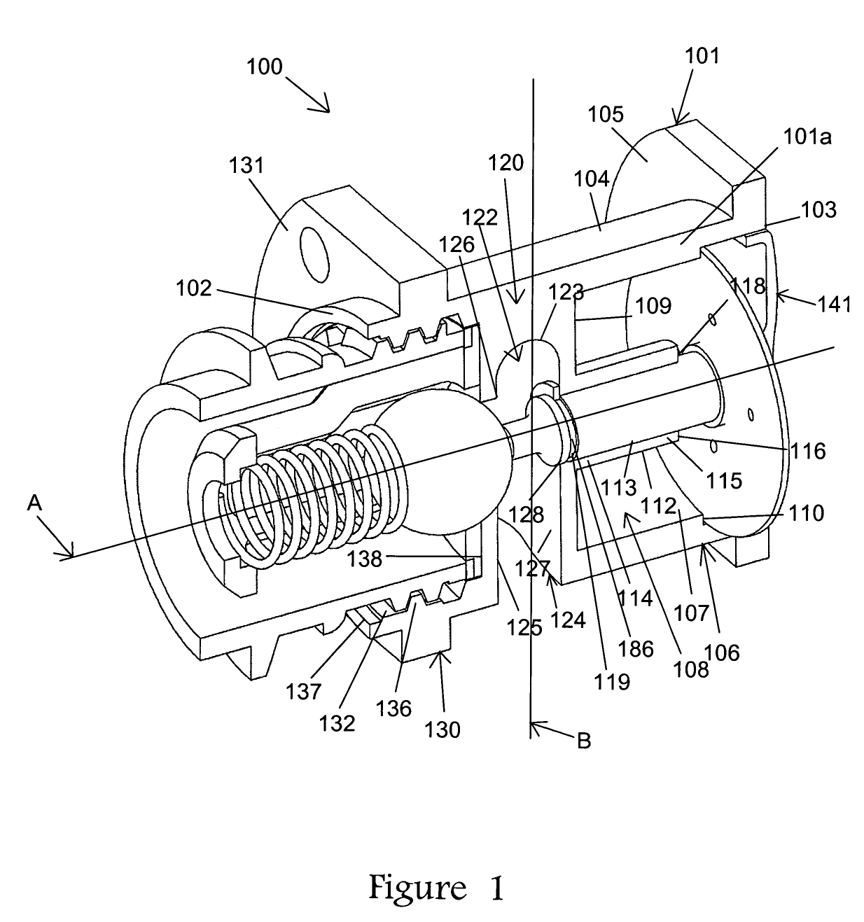

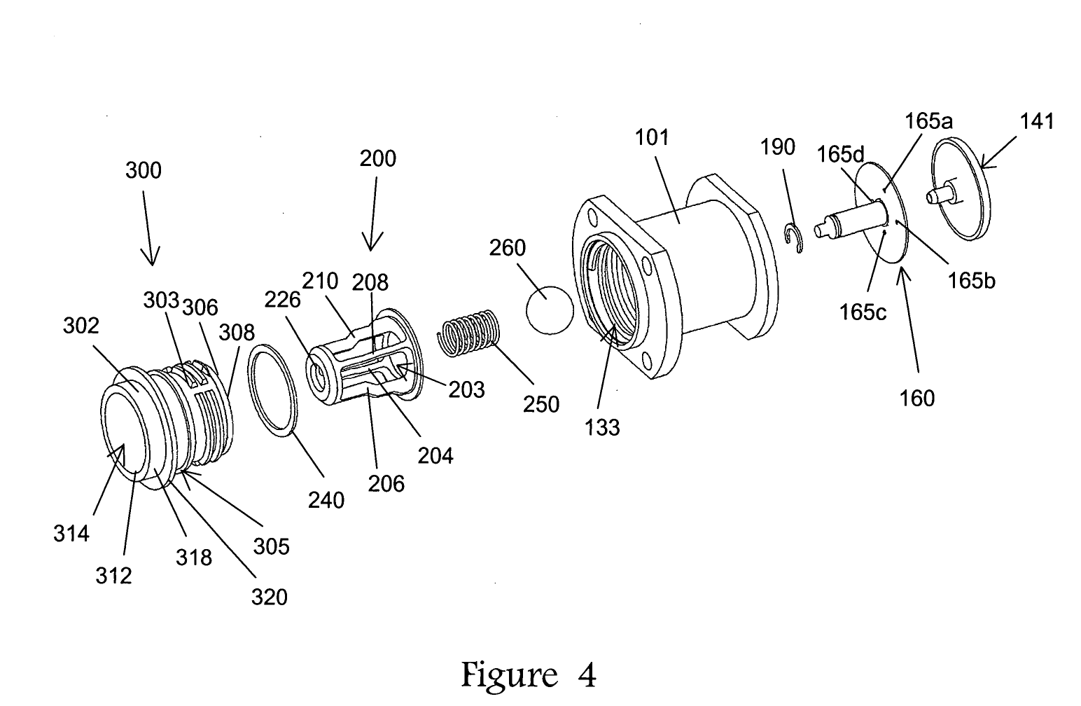

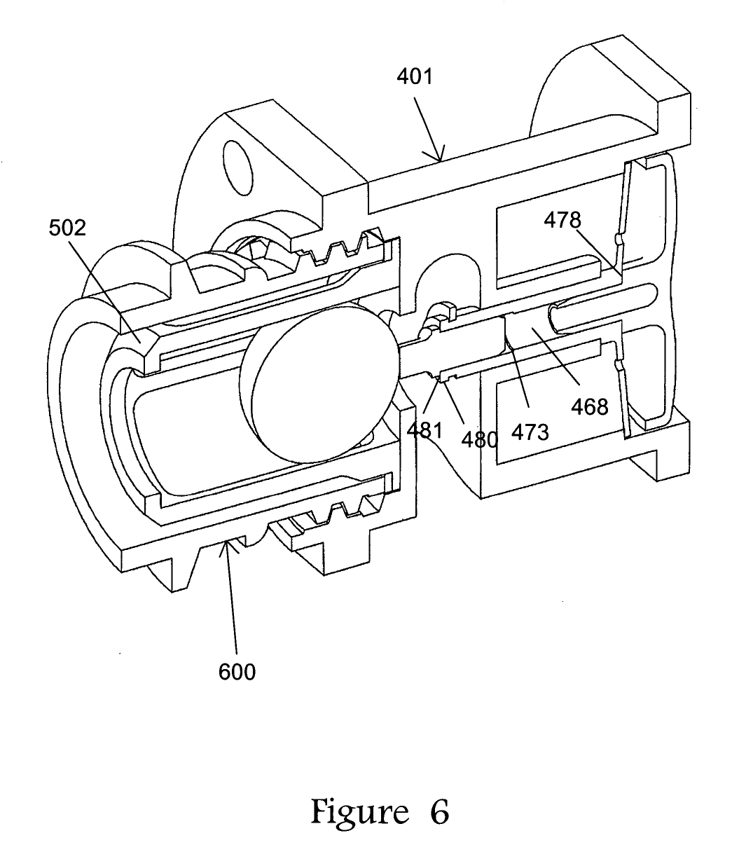

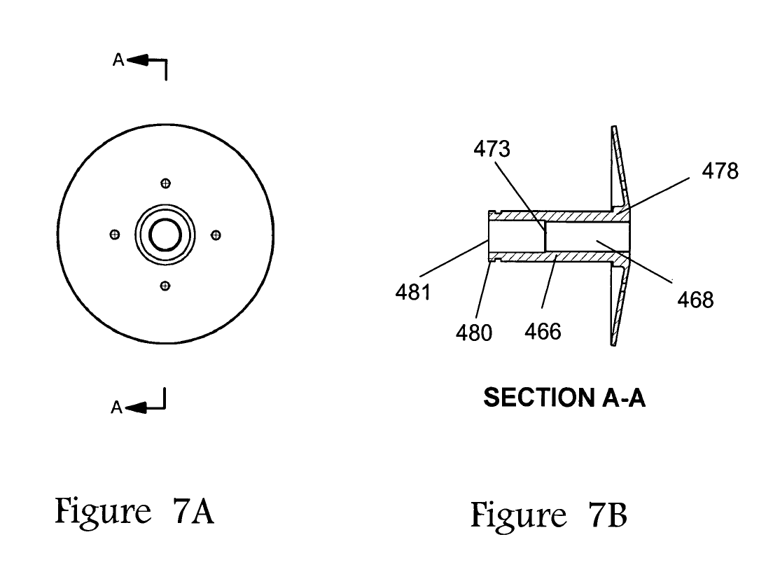

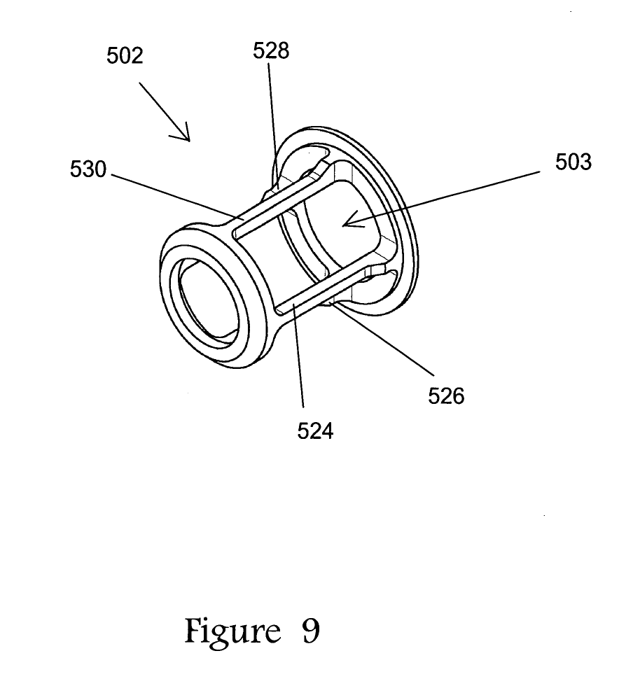

Referring generally to FIGS. 1 through 11D, exemplary embodiments are shown of dispensing valves that may be utilized for dispensing fluid, wherein the fluid is stored under a head of pressure equal to or greater than that provided by gravity. For instance, the fluid utilized with the dispensing valves may be a carbonated beverage wherein there may be pressure variance. Alternatively, the dispensing valves may be used in conjunction with non-carbonated fluids that are being stored under pressure as contemplated by those of ordinary skill in the art. It is to be understood that the dispensing valves may further be utilized for the dispensing of fluids that are under pressure supplied only by gravity. The present invention contemplates the use of dispensing valves for fluids that are stored under any one of or any combination of the previously identified pressure sources.

A dispensing valve 100 according to a first particularly preferred embodiment, as shown in FIGS. 1 through 4, includes a valve body 101 connected with a secondary valve body 301 of a secondary valve assembly 300. The valve body 101 is further connected with an actuator mechanism 140 operationally connected to a check assembly 200. In the current embodiment, the valve body 101 is of a generally tubular configuration including a first section 106, a second section 120, and a third section 130 integrally forming the valve body 101. It is contemplated that valve body 101 is constructed as an integral form providing the various component features and functional capabilities as will be described herein. A wall 101a of the valve body includes an outer wall 104 that forms the tubular/cylindrical shape and defines a circumference of the valve body 101. The defined circumference of the valve body 101 may be constructed as a uniform circumference or may include various circumferential parameters constructed along the length of the valve body 101. It is contemplated that the valve body 101 may be alternately constructed in various forms, such as various polygonal forms (i.e., square, rectangular, hexagonal, octagonal) and other shapes adapted for the application of the dispensing valve 100.

The tubular valve body 101 includes a first “inlet” end 102 which defines an opening and a second “actuator” end 103 that defines an opening and is opposite from first end 102. An axial direction “A” extends from the first to the second end of the valve body 101. In a preferred embodiment, the first and second ends are aligned opposite one another centered about the axial direction A. However, it is contemplated that the first and second ends may be aligned at an angular displacement from the axial direction A.

Further, the present invention contemplates the use of variously positioned axial directions about which the alignment of the valve body 101 may be constructed.

In a preferred embodiment, the wall 101a of the valve body 101 is constructed from a polypropylene copolymer. It is contemplated that the wall 101a may be constructed from various polymeric materials compatible with the fluid being dispensed. For example, thermoplastics such as various polypropylenes or other polyolefins may be utilized. It is contemplated that the material used to construct the wall 101a may be various materials that are suitable for dispensing desired fluids, such as various metals (i.e., tin, aluminum), composites, and the like. The thickness of the wall 101a of the valve body 101 may also be varied to accommodate the needs of dispensing fluids. For example, the wall 101a may be constructed with a minimum average thickness of 0.0625 inches. Alternatively, the wall 101a may be constructed having a minimum average thickness ranging from 0.01 inch to 0.1 inch. Still further, the minimum average wall thickness may be constructed at less than 0.01 or greater than 0.1 in order to allow the proper operation of the dispensing valve 100 without departing from the scope and spirit of the present invention.

It is contemplated that the selection of material may be based upon various considerations, such as the ability of the dispensing valve 100 to withstand vigorous sterilization techniques that may be required, for instance when the dispensing valve 100 is to be used in food applications. These techniques may include irradiating the dispensing valve 100 at up to 5.0 MRAD and subjecting the dispensing valve 100 to high temperature chemical and steam sterilization processes. The material selected may be subjected to these and other types of techniques and processes and be required to be able to withstand them without losing structural integrity, such as becoming brittle, deformed, and the like, which may hinder or prevent the proper operation of the dispensing valve 100.

The outer wall 104 of the valve body 101 includes a grip mechanism 105. In a preferred embodiment, the grip mechanism 105 is a “grip wing” that provides a lip generally perpendicular to the axial direction A and extends at least partially about the circumference of outer wall 104. The grip mechanism 105 may be variously configured as contemplated by those of ordinary skill in the art to promote a secure grasping of the dispensing valve 100 during operation. In the current embodiment, the grip mechanism 105 is proximal to the first end 102 of the valve body 101. Specifically, the grip mechanism 105 forms the outer circumference of the first end 102. It is contemplated that the grip mechanism 105 may be variously positioned upon the valve body 101 forming an outer circumference for the first end 102 or second end 103 or forming an outer circumference along the valve body 101 between the first and second ends.

The dispensing valve 100 includes the first “top” section 106 connected to the second “middle” section 120 which is connected to the third “bottom” section 130. In a preferred embodiment, the first, second and third sections are integral with one another with walls formed between them to delineate the sections and promote the various operational functions taking place within the various sections of the dispensing valve 100. Alternatively, the first, second and third sections may employ various mechanical connectors to secure their positions relative to one another. For instance, the sections may utilize compression locks, snap-fit mechanisms, slide lock mechanisms, rotation lock mechanisms, threaded lock mechanisms, and the like to secure the connection of the sections with one another. The use of these various mechanical connectors and others contemplated by those of ordinary skill in the art may allow the various sections of the dispensing valve 100 to be removed from one another. This may promote a retrofitting capability in the dispensing valve 100, allowing secondary components to be connected for construction of the dispensing valve 100. This may assist in increasing the useful lifespan of the sections of the dispensing valve 100. Further, this modularity may allow the dispensing valve 100 to be adapted for use with variously sized devices, such as variously sized fluid containers and the like.

The wall 101a of the first section 106 includes an inner wall 107, opposite to and integral with outer wall 104, which defines a recessed area 108, bounded on top by the actuator end 103 and a bottom wall 109 opposite the actuator end 103. In a preferred embodiment, the recess 108 is constructed to accommodate the operational connection of the actuator mechanism 140 with the valve body 101. In the current embodiment, the inner wall 107 is constructed having a uniform dimensional structure. However, the inner wall 107 may be alternatively constructed having a tapered structure, concave structure, convex structure, and the like. It is understood that the inner wall 107 may be constructed to provide variously sized recessed areas for accommodating connection with variously sized actuator mechanisms. Further, the depth of the bottom wall 109 from the actuator end 103 may be varied. For instance, the depth may range from one inch (1″) to three inches (3″). Alternatively, the depth may range from less than 1″) to more than 3″).

Disposed upon the inner wall 107, between the actuator end 103 and bottom wall 109, is a stop 110. In the current embodiment, stop 110 is a ledge constructed to at least partially extend about the circumference of the inner wall 107 and proximal to the actuator end 103. The stop 110 is operationally engaged by an outer perimeter 163 of an actuator 160 of the actuator mechanism 140. The stop 110 may be constructed including various dimensions, such as width of ledge, depth from actuator end 103 and may include various alternative features such as various support features to promote the structural integrity of the stop 110. In a preferred embodiment, stop 110 is integral with the inner wall 107. However, it is further contemplated that stop 110 may be connected with the inner wall 107 through use of various mechanical connection mechanisms, such as a friction fit system, a snap-fit system, compression lock mechanism, spring loaded lock mechanism, and the like, which may allow the removal of stop 110 from inner wall 107. Thus, inner wall 107 may be retrofitted with various secondary stops, thereby promoting the use of dispensing valve 100 with various actuator mechanisms.

Further disposed within the recessed area 108 of the first section 106 is a guide member 112. In the current embodiment, the guide member 112 is a generally tubular guide member including a wall 113 extending from the bottom wall 109 towards the actuator end 103. The wall 113 defines a guide channel 117, which extends through the wall 113 from a top port 118 through a bottom port 119. The guide channel 117 allows for the insertion of a plunger member 166, described below, through the top port 118 of the guide channel 117, providing a supporting structure and guiding influence to the plunger member 166. The bottom port 119 of the guide channel 117 aligns with a port 111 of the bottom wall 109 and operatively allows the plunger member 166 to pass through the guide channel 117 and through the port 111, thus promoting the proper operation of the dispensing valve 100 as will be described herein. The thickness of the wall 113 and the diameter and circumference of the guide channel 117, may be varied to accommodate the insertion of variously sized plunger members and/or alternative devices for the operation of the dispensing valve 100.

In a preferred embodiment, a bottom end 114 of the guide member 112 is integral with the bottom wall 109 of the recessed area 108. The connection of the bottom end 114 with the bottom wall 109 aligns the bottom port 119 of the guide channel 117 with the port 111 of the bottom wall 109. Alternatively, the bottom end 114 may be connected with the bottom wall 109 through use of various mechanical connection mechanisms, such as may be contemplated by those of ordinary skill in the art, which may allow the removal of the guide member 112 and promote retrofitting of various secondary guide member devices. It is contemplated that the alignment of the bottom port 119 with the port 111 of the bottom wall 109 may be a direct linear alignment or the ports may be offset from one another or present at various angles relative to one another.

A top end 115 of the guide member 112 is positioned within the recessed area 108 generally centered about the axial direction A and between the bottom wall 109 and actuator end 103. Thus, the top port 118 is positioned in a similar manner within the top section 106 of the valve body 101. The top end 115 further defines a stop 116 that operationally contacts with the actuator mechanism 140 during operation of the dispensing valve 112. In the current embodiment, the stop 116 is a ledge formed by the wall 113 at the top end 115. The width of the stop 116 is defined by the thickness of the wall 113 between the outer diameter of the wall 113 and the inner diameter of guide channel 117. Alternatively, the stop 116 may be constructed as a series of posts about the top end 115, a plurality of protrusions, and the like in order to promote proper operation of the dispensing valve 112. The dimensional characteristics of stop 116 may be varied as contemplated by those of ordinary skill the art to promote the effective operation of the stop 116 during operation of the dispensing valve 100.

It is contemplated that the length of the guide member 112 may be varied, such that the top end 115 may be positioned more or less proximal to the actuator end 103. This may advantageously allow the guide member 112 to provide increased guidance and support capabilities to the operation of the plunger member 166. It is further contemplated that the guide member 112 may be constructed with a wall 113 of various dimensional characteristics. For instance, the wall 113 may be formed having a tapered top end 115 compared to the bottom end 114.

Alternatively, the wall 113 may include or be connected with various secondary support members which may connect with the guide member 112 on one end and the inner wall 107 or bottom wall 109 on an opposite end. For instance a support member may be constructed as a wall, beam, post, strut, and the like, which extends from the inner wall 107 to the wall 113 of the guide member 112. Various numbers of secondary support members may be utilized to provide the structural support for the proper operation of the dispensing valve 100. The dimensional characteristics (i.e., width, length, thickness, and the like) may be varied to promote the structural integrity of the guide member 112. It is further contemplated that the secondary support members may vary the size and shape of recessed area 108 of the first section 106. The variance of the recessed area 108 may provide different operational parameters for the dispensing valve 100, which may advantageously promote the efficient operation and ease of use of the dispensing valve 100.

The middle “second” section 120 includes a discharge channel 122 defined by a closed end 123 and an outlet port 124 opposite the closed end 123. In the current embodiment, the second section 120 is integral with the first section 106. The discharge channel 122 extends a distance within the second section 120 along an axial direction “B” which is generally perpendicular to axial direction A. It is contemplated that the direction along which the discharge channel 122 extends within the second section 120 may vary, such that the discharge channel 122 may be oriented in an angularly displaced manner from the perpendicular to axial direction A. An angular displacement of the discharge channel 122 from axial direction B may promote optimized operation of the dispensing valve 100. For instance, an angular displacement may assist in preventing back flow, promote flow rate control, promote ease of use, and various other advantages as may be contemplated by those of ordinary skill in the art.

The discharge channel 122 is further defined by a bottom wall 125, which includes an inlet port 126, and an upper wall 127 opposite the bottom wall 125, which includes an actuator port 128. The upper wall 127 is integral with the bottom wall 109 of the first section, thereby providing part of the integral connection between the first and second sections. In operation, actuator port 128 is aligned with the port 111 of the bottom wall 109, which is in turn aligned with the bottom port 119 of the guide channel 117. Alternatively, the various ports may be aligned in a non-linear manner and/or present at various angles relative to one another as may be contemplated by those of ordinary skill in the art to promote the proper operation of the dispensing valve 100.

The closed end 123, bottom wall 125, and top wall 127 are constructed to provide proper structural integrity to allow for the flow of fluid into and through the discharge channel 122. These features of the second section 120 may avoid structural breakdowns, such as warping, distending, and the like through construction employing sufficiently rigid materials and utilizing proper thickness of materials that assists in providing these features with the capability of avoiding unwanted damage. In the current embodiment, the material used in constructing the second section 120 is the same polypropylene copolymer used throughout the valve body 101. Alternative materials, such as those described previously, may be employed to promote the proper operation of the second section 120.

In a preferred embodiment, the actuator port 128 is optimally configured to provide for the slidable operation of the plunger member 166 and a fluid tight fit about the plunger member 166 to assist in avoiding unwanted back flow of fluid from the discharge channel 122 into the first section 106. Thus, the dimensional characteristics of the actuator port 128 correspond with various dimensional characteristics of the plunger member 166. Alternatively, the actuator port 128 may be constructed having dimensional characteristics that differ from those of the plunger member 166. Further, a secondary sealing device, such as a seal ring, gasket, and the like, may be employed to provide the fluid tight fit between the actuator port 128 and plunger member 166.

The dimensional structure of the discharge channel 122 may be varied to accommodate the needs of various manufacturers and users of the dispensing valve 100. For instance, flow rate may be a primary concern for a user of the dispensing valve 100; therefore, the discharge channel 122 may be constructed to optimize the flow rate. This may be accomplished through differently configuring the length and/or width (distance between bottom and top walls). Alternatively, the discharge channel 122 may be optimally constructed to provide a flow of fluid under a pre-specified discharge pressure parameter. Still further, the width at various points along the length of the discharge channel 122 may be varied to accommodate proper operation and flow rate for the dispensing valve 100. Thus, the dimensional structure of the discharge channel 122 may vary without departing from the scope and spirit of the present invention to provide a proper flow rate of fluid being discharged from the dispensing valve 100.

A third “bottom” section 130 of valve body 101 is integrally connected with the second section 120. The third section 130 includes an outer ring 131 that circumscribes the outer wall 104 of the third section 130. The third section 130 further includes an inner wall 132 defining a recessed area 133 bounded by the first “inlet” end 102 and a top wall 138 opposite the first end 102. The top wall 138 further includes a valve port 139 and is integrally connected with the bottom wall 125 of the second section 120. In operation, the valve port 139 is directly aligned with the inlet port 126 through the bottom wall 125 of the second section 120 to promote the proper operation of the dispensing valve 100. It is contemplated that the alignment of the valve port 139 and inlet port 126 may be non-linear and/or present at various angles relative to one another in order to promote the proper operation of the dispensing valve 100.

Circumferentially disposed about the inner wall 132 is a connector mechanism 136. In a preferred embodiment, the connector mechanism 136 is a threaded connection between the valve body 101 and a second valve body 300, described below. It is contemplated that other mechanical connector mechanisms may be employed, such as a press-fit connector mechanism, compression lock mechanism, snap-fit mechanism, spring-loaded locking mechanism, and the like, which may provide a tight connection.

It is to be understood that the connector mechanism 136 and the alternative connector mechanisms described above may allow the removal of the secondary valve assembly 300 from the valve body 101. Promoting the removal capability may be a release mechanism included within the third section 130 of the valve body 101. The release mechanism may be variously configured mechanisms, such as a button, tab, latch, toggle, slide, and the like which allows the user to engage with and cause the release of the connection between the valve body 101 and the secondary valve assembly 300.

It is further contemplated that auxiliary sealing elements, such as resilient O-rings or other gaskets may be employed to secure the connection between the valve body 101 and the secondary valve assembly 300. In a preferred embodiment, a seal disk 240 is utilized to promote the connection between the secondary valve assembly 300 and the valve body 101. The seal disk 240 may be formed of various resilient materials, such as rubber, plastic, and the like, which promote a fluid tight fit system.

The recessed area 133 is optimally sized for connecting with the secondary valve assembly 300. In the current embodiment, the inner wall 132 including the connector mechanism 136 provides this optimal dimensional sizing. It is contemplated that inner wall 132 and the recessed area 133 may include various sizing features, such as a tapering of the inner wall 132, increasing the thickness between the outer wall 104 and the inner wall 132. Further, various secondary structures, such as the sealing ring/gasket previously mentioned, spacer devices, and the like may be included to provide a desired dimensional sizing for connection with variously configured secondary valve bodies.

It is contemplated that the first section 106, second section 120, and third section 130 may be connected through utilization of various mechanical connection mechanisms. For example, each section may include a threaded connector mechanism allowing the sections to be screwed together. Alternatively, the sections may include the proper mating components for a compression lock mechanism. Further, each section may be constructed to connect together via a spring-loaded locking mechanism. Various other mechanical connection mechanisms as may be contemplated by those of ordinary skill in the art may be employed to provide the secure connection of the sections and the operability of the dispensing valve 100. It is further contemplated that the sections may include differently configured mechanical connection mechanisms or the same mechanical connection mechanisms. The use of these mechanical connectors may allow for the retrofitting of the first, second and third sections with differently configured secondary sections. This may promote an increase in the useful lifespan of each section and ease of use of the dispensing valve 100.

The actuator mechanism 140 includes a push button 141 for manual engagement by a user to operate the dispensing valve 100. In a preferred embodiment, push button 141 is formed as a disk having a generally planar top surface 142 and bottom surface 143 on the opposite side from the top surface 142. Circumscribing the outer perimeter of bottom surface 143 is an outer ring 144 including an outer ring edge 145. It is to be understood that the bottom surface 143 may be employed without the outer ring 144 and allow for the proper operation of the dispensing valve 100.

Extending downward from and centrally located on bottom surface 143 is an engagement pin 146 including an engagement pin channel 152 and channel outlet port 154. In a preferred embodiment, the engagement pin 146 is constructed in an integral manner with the bottom surface 143 of push button 141. A ring support member 148 is connected about the engagement pin 146 proximal and/or adjacent to the bottom surface 143 of the push button 141. It is contemplated that the ring 148 may be mechanically connected allowing the ring 148 to be removed. In the current embodiment, the ring 148 is integral with the engagement pin 141 and the bottom surface 143. The ring 148 defines a stop (ring ledge) 150 on the end of the ring 148 opposite its integral connection with the bottom surface 143. The stop 150 is generally parallel with the bottom surface 143. Alternatively, the stop 150 may be variously configured as contemplated by those of ordinary skill in the art.

The engagement pin 146 is further constructed to allow for insertion through a port 171 which extends through a top side 162 of an actuator 160 and a top side 170 of the plunger member 166 into an actuator channel 168 defined by an inner wall 167 of the plunger member 166. The port 171 is generally positioned at the mid-point of the top side 162 and 170, centered along the axial direction A, which typically corresponds with the centerline (axis) of the actuator channel 168. Thus, depression of push button 141 downward into the recessed area 108 causes the actuator 160 and plunger member 166 to move downward. The plunger member 166 is received within the guide member 112 disposed within the recessed area 108 of the first section 106. The plunger member 166 is slidably mounted with the guide member 112 and allowed to move within the guide member 112. Thus, the downward movement of the push button 141 causes the plunger member 166 to move downward through the guide member 112.

In a preferred embodiment, pin 146 is inserted through port 171 and received within the actuator channel 168 providing a secure connection and seating stop 150 against the top side 162 of the actuator 160. During operation, the depression of push button 141 causes the depression of actuator 160 and plunger member 166 through contact of the stop 150 with the top side 162 of the actuator. It is contemplated that the operational interaction between the push button 141 and actuator 160 may be accomplished utilizing various constructed stop(s) and/or alternative devices. For instance, the stop 150 instead of being a ring ledge may be constructed as a series of posts extending downward from bottom surface 143 for contacting with actuator 160. Variously designed and constructed strut devices may be included on bottom surface 143 for contacting with actuator 160.

In a preferred embodiment, the actuator 160 is formed integrally with the plunger member 166. Alternatively, the actuator 160 may be connected with the plunger member 166 through utilization of various fastening mechanisms and connection devices. It is contemplated that the plunger member 166 may be removed from its connection with the actuator 160 when utilizing the various fastening mechanisms and connection devices. This may allow for the retrofitting of various secondary plunger members with the actuator 160 and/or various secondary actuators with the plunger member 166.

The actuator 160 includes the top side 162 and bottom side 164. A support ring 174 is further connected about the plunger member 166 proximal and/or adjacent to the bottom side 164. It is contemplated that the support ring 174 may be mechanically connected allowing the ring 174 to be removed. In the current embodiment, the support ring 174 is integral with the plunger member 166 and the bottom side 164. The support ring 174 defines a stop (support ring ledge) 176 on the end of the ring 174 opposite its integral connection with the bottom side 164. The stop 176 is generally parallel with the bottom side 164. Alternatively, the stop 176 may be variously configured as contemplated by those of ordinary skill in the art. In operation, the stop 176 contacts against the stop 116 of guide member 112 when the push button 141 is depressed resulting in the downward movement of the actuator 160 including the plunger member 166 received within the guide member 112. It is contemplated that the stop 176 may be of similar or dissimilar dimensional configuration as that for stop 116. The dimensions of the stops may promote the efficient operation of the dispensing valve 100. Stop 176 acts against the stop 116 of guide member 112 and determines the distance plunger member 166 and thusly the actuator 160 may be moved when force is exerted by the user of the dispensing valve 100 upon the push button 141. Therefore, the distance traveled by the stop 176 in order to contact against the stop 116 of guide member 112 is the amount (distance) of travel allowed for the plunger member 166 and actuator 160.

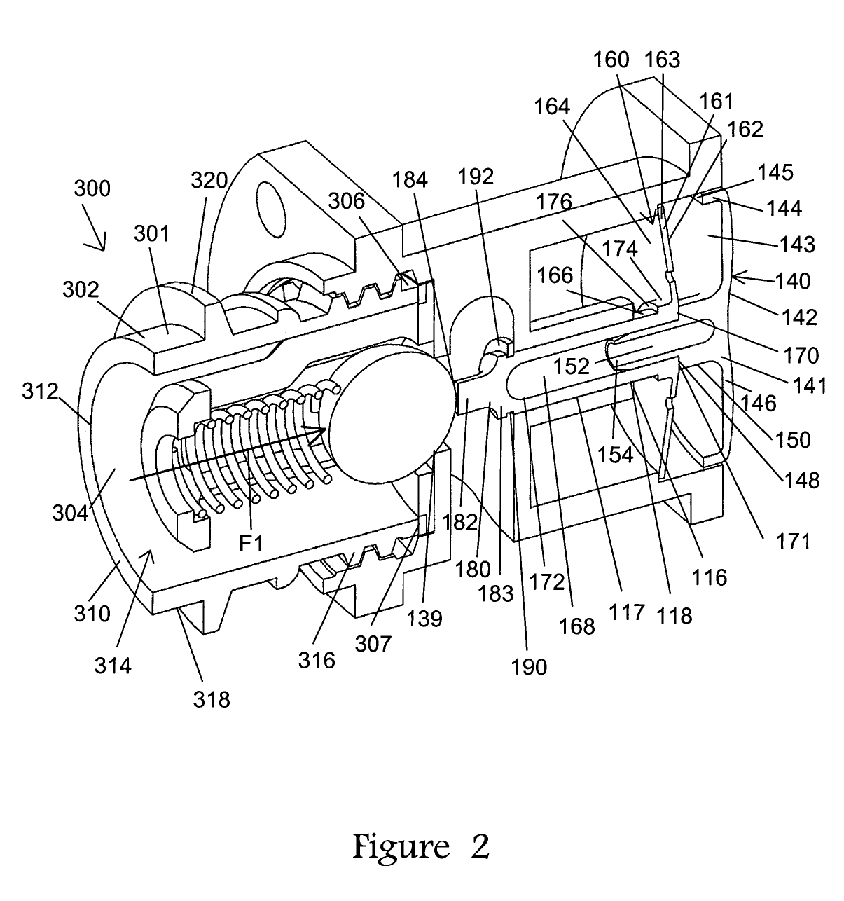

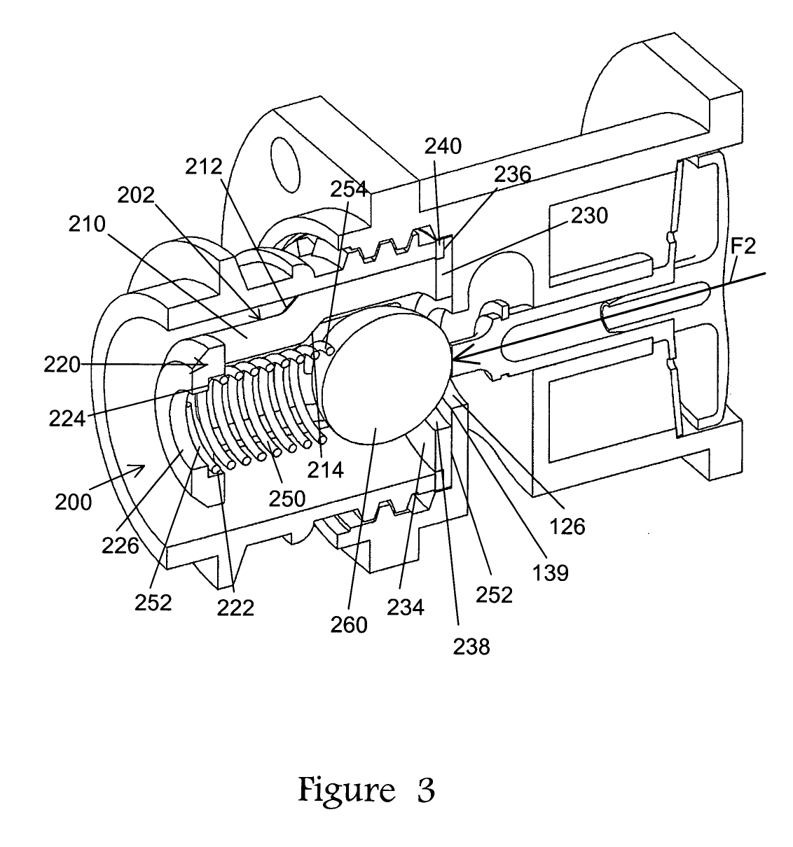

In the current embodiment, the actuator 160 is a dome-shaped, resilient disk 161 having an outer perimeter 163. The size of the disk 161 places the outer perimeter 163 in operational contact with stop 110 disposed on the inner wall 107 of the top section 106. The thickness of the material used for construction of the disk 161 may vary to provide different operational forces, such as closing forces described below. In a preferred embodiment, the resilient disk 161 is approximately twelve thousandths of an inch at the outer perimeter 163 and approximately eighteen thousandths of an inch at the juncture with plunger member 166. Stop 110, being a ledge, provides a secure seat against which the outer perimeter 163 may rest allowing the resilient disk 161 to be deflected from a first “closed” position into a second “open” position, which provides for proper operation of the dispensing valve 100 and back into the first position. The first closed position is illustrated in FIGS. 1 and 2 while the second open position is shown in FIG. 3.

In a preferred embodiment, the resilient disk 161 is generally conical and about one inch (1″) in diameter, with an included angle of about one hundred sixty degrees (160°). That is, the wall of the resilient disk 161 is positioned at an angle of about ten degrees (10°) to the plane perpendicular to the axial direction A of the dispensing valve 100. It is contemplated that the resilient disk 161 may vary in diameter from less than one inch to greater than one inch and that the included angle may vary from less than 160° to greater than 160° without departing from the scope and spirit of the present invention. This variance in construction may allow the resilient disk to assist in increasing the ease of use of the dispensing valve 100, promote the use of the dispensing valve 100 with numerous devices, and provide other advantages as contemplated by those of ordinary skill in the art.

The resilient disk 161 may optionally include a plurality of ports 165a, 165b, 165c, and 165d, which extend from the top 162 through the bottom 164. This plurality of ports assist the operation of the resilient disk 161 by providing a venting function whereby media (i.e., air) trapped between the bottom 164 of the disk 161 and the bottom wall 109 of the recessed area 108 is allowed to escape. This venting may eliminate the build up of or reduce any pressure forces (i.e., air pressure), which may promote an easier operation of the dispensing valve 100. It is contemplated that the resilient disk 161 may include various porting configurations to allow proper venting and thus proper operation of the actuator mechanism. For instance, the disk 161 may include an outer perimeter 163 connected by a plurality of struts to an inner junction which connects to the plunger member 166. The space in-between these posts may simply be left open or may be at least partially filled with material. The amount of material filling the spaces may be based on operational tolerances, such as the amount of closing force to be provided. Thus, the present invention contemplates multiple disk configurations that provide a perimeter to engage with stop 110 and a junction to be engaged by a user and connect with plunger member 166.

The present invention further contemplates that the dispensing valve 100 may not include push button 141. A user of dispensing valve 100 may directly engage with resilient disk 161 of actuator 160. Alternatively, the push button 141 may be variously configured to provide the user interaction for the dispensing valve 100. For instance, a post member may extend from the actuator end 103 a pre-determined distance to be engaged by a user. A dispensing lever may be operationally connected with the actuator 160 to allow a user to control operation of the dispensing valve 100. Various mechanical devices may be employed to provide user control over the operation of the actuator 160 of the dispensing valve 100 without departing from the scope and spirit of the present invention.

A bottom end 172 of actuator channel 168 is generally disposed proximal to a bottom end 180 of the plunger member 166. In the current embodiment, the bottom end 172 is a closed end providing the actuator channel 168 with a generally cylindrical tube appearance within the plunger member 166. A retention device connection mechanism 190 is generally disposed proximal to the bottom end 180, generally circumscribing the bottom end 180. In a preferred embodiment, the retention device connection mechanism 190 is a groove within an outer wall 169 of the plunger member 166 proximal to the bottom end 180. A retention device 192 may be connected with the retention device connection mechanism 190. In the current embodiment, the retention device 192 is a retaining ring that is connected within the groove. The retaining ring connected within the groove provides a stop for the plunger member 166 as it moves within the guide member 112 and exits through the bottom port 119 and actuator port 128. In operation, the retaining ring may contact against the upper wall 127 adjacent to the actuator port 128 of the discharge channel 122. This contact may assist in preventing the plunger member 166 from being removed from its slidable connection with the guide member 112. Thus, the retention device connection mechanism 190 and the retention device 190 assist in promoting the effective operation of the dispensing valve 100.

It is contemplated that the retention device connection mechanism 190 and retention device 190 may be implemented as various mechanisms that provide a stop to assist in preventing the plunger member 166 from disengaging with the guide member 112. For instance, a pin inserted within a recess may provide the stop needed for the present invention. Alternatively, a ball joint mechanism may be employed that provides a specified stopping power but is further constructed to allow a user to overcome the stopping force and remove the plunger member 166 from its seat within guide member 112. Further, a tab, post, ledge, and the like may be connected with the plunger member 166 in the position for retention provided by the present invention.

The bottom end 180 of the plunger member 166 includes an actuator pin 182 including a top side 183 and a bottom side 184. In a preferred embodiment, the actuator pin 182 is integrally formed with the bottom end 180 of the plunger member 166. Thus, the bottom end 180 of the plunger member may provide the operational functions described herein for the actuator pin 182. In alternative embodiments, the top side 183 may be connected with the bottom end 180 through use of various mechanical connection mechanisms, such as a compression lock mechanism, friction fit mechanism, snap-fit mechanism, threaded connector mechanism with complementary structure on the bottom end 180, and the like. These various mechanisms may provide for a secure connection and allow the removal of the actuator pin 182 from the bottom end 180. This promotes retrofitting of and by the actuator pin 182 and the plunger member 166.

The bottom side 184 of the actuator pin 182 provides a strike by which the actuator pin 182 contacts against other surfaces. In the current exemplary embodiment, the actuator pin 182 is a solid piece of material contoured from the top side 183 to the bottom side 184. The contouring provides a narrower profile for the bottom side 184. The contouring and profile given the bottom side 184 may be varied as contemplated by those of ordinary skill in the art to provide a more efficient and easy to use strike.

In a preferred embodiment, the various features of the actuator mechanism 140 are constructed from a polypropylene copolymer, similar to that used to construct valve body 101. In the alternative, these features may be constructed from various polymeric materials compatible with the fluid being dispensed. For example, thermoplastics such as various polypropylenes or other polyolefins may be utilized. It is contemplated that the material used to construct these features may be various materials that are suitable for dispensing desired fluids, such as various metals (i.e., tin, aluminum), composites, and the like. The thickness of the various features may also be varied to accommodate the needs of dispensing fluids. For example, the features of the actuator mechanism 140 may be constructed having a minimum average thickness ranging from 0.001 inch to 0.1 inch. Still further, the minimum average thickness may be constructed at less than 0.01 or greater than 0.1 in order to allow the proper operation of the dispensing valve 100 without departing from the scope and spirit of the present invention.

It is contemplated that the selection of material may be based upon various considerations, such as the ability of the dispensing valve 100 to withstand vigorous sterilization techniques that may be required, for instance when the dispensing valve 100 is to be used in food applications. These techniques may include irradiating the dispensing valve 100 at up to 5.0 MRAD and subjecting the dispensing valve 100 to high temperature chemical and steam sterilization processes. The material selected may be subjected to these and other types of techniques and processes and be required to be able to withstand them without losing structural integrity, such as becoming brittle, deformed, and the like, which may hinder or prevent the proper operation of the dispensing valve 100.

A check assembly 200, connected with the secondary valve assembly 300, which is connected with the third section 130 of the valve body 101, is operationally connected with the actuator mechanism 140. In the current exemplary embodiment, the check assembly 200 includes a cage 202 which is constructed from a first cage arm 204, a second cage arm 206, a third cage arm 208 and a fourth cage arm 210. An inner surface 234 of a top ring 230 connects with the top ends of each of the four cage arms and an inner surface 222 of a bottom cap 220 connects with the bottom ends, which are opposite the top ends, of each of the four cage arms.

The secondary valve body 301 may be constructed from various polymeric materials compatible with the fluid being dispensed. For example, a thermoplastic such as polypropylene or other polyolefin may be utilized. In a preferred embodiment, a polypropylene copolymer similar to that used for the valve body 101 and actuator mechanism 140 is used for the construction of the secondary valve body 301. It is contemplated that the material used to construct the secondary valve body 301 may be various materials that are suitable for dispensing desired fluids, such as various metals (i.e., tin, aluminum), composites, and the like.

The inner walls of the cage arms in connection with the top ring 230 and bottom cap 220 define a cage channel 203 that extends from the top ring 230 to the bottom cap 220. By way of example, the fourth cage arm 210 is described below and it is to be understood that the first, second and third cage arms are similar in every respect. The fourth cage arm 210 includes an inner surface 214 and an outer surface 212. The inner surface 214 provides for the definition of the cage channel 203, as described above. The outer surface 212 is at least partially in contact with an inner wall 304 of the secondary valve assembly 300.

The fourth arm 210 is contoured providing the inner surface 214 and outer surface 212 with a contouring that promotes the proper operation of the check assembly 200. For instance, an upper section 211 of the fourth cage arm 210 is contoured to provide a larger cage channel 203 area than a lower section 213 of the fourth cage arm. In operation, the upper section 211 of the fourth cage arm 210, in conjunction with similar upper section contouring of the other cage arms, allows a sealer 260, in the current embodiment represented by ball 260, to be seated within the cage channel 203 among the upper sections of the four cage arms. Further, the ball 260 is allowed to move within the upper sections, which promotes the proper operation of the dispensing valve 100, further described below. The lower sections of the four cage arms are similarly contoured to provide a narrower cage channel 203. This narrowing of the cage channel 203 allows for the proper operation of a biasing mechanism 250, in the current embodiment represented by spring 250, seated within the cage channel 203 proximal to the lower sections of the cage arms. The biasing mechanism 250 operates to provide a sealing force F1 that is exerted against the sealer 260 in order to maintain the sealer 260 in the first “closed” position wherein fluid is not allowed to pass through top port 139 and inlet port 126 into and through discharge channel 122. The four cage arms are a structural support to the biasing mechanism 250 and sealer 260 by defining the cage channel 203 within which the biasing mechanism 250 and sealer 260 operate.

The length of the four cage arms may be varied to accommodate the need for different cage sizes that may be employed in the present invention. For instance, the cage arm length may preferably range between one-half inch (0.5″) to two inches (2″). Alternatively, the cage arms may be less than 0.5″ or greater than 2″ in length without departing from the scope and spirit of the present invention. The thickness of the cage arms may vary to promote the structural integrity of different cage sizes. For example, the cage arm thickness may preferably range between 0.01 inch and 0.5 inch. Alternatively, the thickness of the cage arms may be less than 0.01 inch or greater than 0.5 inch.

The bottom cap 220 includes a stop 224 defined on the inner surface 222. In a preferred embodiment, the stop 224 is a ledge upon which a first end 252 of the spring 250 seats. The ledge 224 provides the stop for one end of spring 250 during the operation of the dispensing valve 100. A second end 254 of the spring 250, opposite the first end 252, contacts against the ball 260 providing a seat for the ball 260. Bottom cap 220 further includes a port 226. The port 226 is optimally sized to allow the flow of fluid through while not interfering with the operation of the biasing mechanism 250 seated against the inner surface 222 of the bottom cap 220. The dimensions of the bottom cap 220 may vary to provide necessary structural integrity and support for differently sized cages. Thus, the outer and inner dimensions may vary and the dimensions of the stop 224 and port 226 may vary. It is further contemplated that the dimensions given the various features of the bottom cap 220 may be established in relation to one another. For instance, the stop 224 may be sized in a 1:3 ratio as compared to the size of the inner wall. The port 226 may be sized in a 1:4 ratio as compared to the size of the stop 224.

The top ring 230 includes an outer surface 232 and the inner surface 234. The inner surface 234 further defines a stop 236, which is circumscribed about the perimeter of the inner surface 234. In a preferred embodiment, the stop 236 is a ledge that provides a seat and structural support for a seal disk 240. The seal disk 240 assists in promoting a fluid-tight connection between the third section 130 of the valve body 101, check valve 200 and the secondary valve assembly 300. When properly connected, the outer surface 232 is pressed/seated against the first end 138 of the bottom section 130 of the valve body 101. This seating of the outer surface 232 further positions a port 238 disposed in the top ring 230 in alignment with the valve port 139 of the third section 130 and inlet port 126 of the second section 120. The dimensional structure of the port 238 allows the sealer 260 to extend through and into operational contact with the valve port 139 and inlet port 126. Thus, the structure of the port 238 may be determined by the dimensional structure of the sealer 250, the valve port 139, and inlet port 126. Alternatively, the port 238 may be dimensionally sized as a ratio of the size of the top ring 230.

The check assembly 200 may be constructed from various polymeric materials compatible with the fluid being dispensed. For example, a thermoplastic such as polypropylene or other polyolefin may be utilized. In a preferred embodiment, a polypropylene copolymer similar to that used for the valve body 101 and actuator mechanism 140 is used for the construction of the check assembly 200. The biasing mechanism 250 (spring) is preferably constructed of a metal, such as steel, to provide a pre-determined tensile strength which exerts a specified amount of force upon the sealer 260. Various other materials as contemplated by those of ordinary skill in the art may be used in the construction of biasing mechanism 250. The sealer 260 may be constructed of a similar material as that used to construct the check assembly 200 and/or biasing mechanism 250. Similar to the biasing mechanism 250, various other materials as contemplated by those of ordinary skill in the art may be used for the construction of the sealer 260.

It is contemplated that the material used to construct the check assembly 200 may be various materials that are suitable for dispensing desired fluids, such as various metals (i.e., tin, aluminum), composites, and the like. The material used to construct the check assembly 200 may be based upon various considerations, such as the ability of the dispensing valve 100 to withstand vigorous sterilization techniques that may be required, for instance when the dispensing valve 100 is to be used in food applications. These techniques may include irradiating the dispensing valve 100 at up to 5.0 MRAD and subjecting the dispensing valve 100 to high temperature chemical and steam sterilization processes. The material selected may be subjected to these and other types of techniques and processes and be required to be able to withstand them without losing structural integrity, such as becoming brittle, deformed, and the like, which may hinder or prevent the proper operation of the dispensing valve 100.

It is further contemplated that alternative mechanisms for providing a retractable seal and sealing force against the top port 139 may be utilized by the present invention. For example, the check assembly may provide various fixed arm mechanisms connected with the actuator mechanism for retracting a valve seal member from its seat about the top port 139. The actuator mechanism may be operationally connected with a threaded screw-type seal that activates a rotational force to retract and extend a valve seal member. It is understood that the device employed to provide the control over the flow of fluid into the discharge channel 122 may be varied without departing from the scope and spirit of the present invention.

The secondary valve assembly 300 includes a generally cylindrical secondary valve body 301 having an outer wall 302 and an inner wall 304, which defines a secondary valve body channel 314 extending the length of the secondary valve body 301. The secondary valve body 301 may be constructed from various polymeric materials compatible with the fluid being dispensed. For example, a thermoplastic such as polypropylene or other polyolefin may be utilized. In a preferred embodiment, a polypropylene copolymer similar to that used for the valve body 101 and actuator mechanism 140 is used for the construction of the secondary valve body 301. It is contemplated that the material used to construct the secondary valve body 301 may be various materials that are suitable for dispensing desired fluids, such as various metals (i.e., tin, aluminum), composites, and the like. Further, the material employed may allow for the use of various sterilization techniques and processes without resulting in unwanted damage to the secondary valve assembly 300, similar to that described previously with respect to the valve body 101, actuator mechanism 140, and check assembly 200.

Circumscribing the outer wall 302 proximal to a top section 303 is the valve connector mechanism 316. The valve connector mechanism 316 allows the secondary valve assembly 300 to connect with the valve body 101. The connector mechanism 316 is correlated in construction with the connector mechanism 136 of the third section 130. As previously described, the connector mechanism 136 is a series of ridges or threads that allow for a connection to be made between the valve body 101 and the secondary valve assembly 300. Thus, in a preferred embodiment, the connector mechanism 316 includes a series of ridges or threads that complement those of the connector mechanism 136. It is contemplated that various other mechanical connector mechanisms, such as a compression lock mechanism, snap fit mechanism, spring loaded lock mechanism, and the like, may be employed to provide for the connection of the secondary valve assembly 300 with the valve body 101.

The secondary valve body 301 is further defined by a top 306 including a top edge 307 and a top port 308. Opposite the top 306 is a bottom 310 including a bottom edge 311 and a bottom port 312. The secondary valve body channel 314 is defined on either end by the top and bottom ports. Thus, the secondary valve body channel 314 is generally a hollow cylinder. The dimensions of the circumference of the inner wall 304, which defines the channel 314, allow the check assembly 200 to be inserted within the channel 314 for operation of the dispensing valve 100. Thus, construction of the secondary valve assembly 300 and the check assembly 200 may be dependent upon one another. It is further contemplated that the secondary valve assembly 300 may be constructed to employ secondary connector devices, such as seal rings, gaskets, support posts, inner wall joists, and the like, to provide a secure connection with the check assembly 200.

The connection between the valve body 101, the check assembly 200, and the secondary valve assembly 300 further includes the press-fitting of the top edge 307 against the sealing disk 240, which is seated within stop 236 of the top ring 230 of the check assembly 200. The connection between the top edge 307 and the sealing disk 240 provides a fluid-tight barrier. Further, with the cage 202 received within the channel 314 the upper sections of the outer surfaces of the cage arms provide a secondary friction-fit connection.

A bottom section 305 of the secondary valve body 301 further includes a container connection mechanism 318 and a positioning ring 320. The positioning ring 320 circumscribes the outer wall 302 of the secondary valve body 310 in a position adjacent to or proximal with the container connection mechanism 318. In operation, the container connection mechanism 318 is connected with a container storing fluid. The container connection mechanism 318 may be inserted within the container until an outer surface of the container abuts the positioning ring 320. Optionally, the bottom section may be inserted further into a container up to a bottom edge of valve body 101 (such as to outer ring 131) without departing from the spirit and scope of the invention.

Having identified and described features of the present invention, further clarification is provided by an operational description. In a preferred embodiment, the secondary valve body 301 connects the dispensing valve 100 with a container that is storing fluids under a head of pressure greater than the force of gravity. The bottom port 312 is in communication with the interior of the container and allows the fluid to flow into the secondary valve body channel 314. As the fluid progresses through the secondary valve body channel 314 it enters into the recessed area 133 of the third section 130 of the valve body 101 where it comes into contact with the check assembly 200. In the “closed” position, the sealer (ball) 260 is seated on one end against the biasing mechanism (spring) 250 and on the opposite end against the port 238. The spring 250 exerts force “F1” along the axial direction “A” against the ball 260, biasing the ball 260 into a position wherein the ball 260 contacts and seals the port 238. Port 238 is aligned with valve port 139 of the third section 130 and inlet port 126 of the second section 120, thus, the ball 260 further provides a fluid-tight, pressure fit seal of these aligned ports when in the “closed” position. Therefore, the fluid received within the secondary valve body channel 314 and the third section 130 of the valve body 101 is prevented from entering the discharge channel 122 through the inlet port 126.

The spring 250 is of sufficient strength to maintain the ball 260 in this position, which corresponds with the first “closed” position. It is to be understood that the fluid pressure may also provide a force against the ball 260 further assisting in positioning the ball 260 as a seal against the port 238, valve port 139, and inlet port 126 and assisting in preventing the unwanted flow of fluid into the discharge channel 122. It is contemplated that the seal provided by the ball 260 through the efforts of the biasing mechanism as may be assisted by the fluid pressure may promote the effective sealing of the ports described previously to prevent the unwanted flow of fluid into the discharge channel 122 during periods where the fluid pressure is increased. For example, the container may be dropped and/or shaken which often results in an increase in the fluid pressure within the container. The check assembly 200 may utilize the increased fluid pressure to further tighten the seal of the ports by exertion of a greater pressure in the general F1 direction, as provided by the biasing mechanism 250, upon the ball 260. Thus, the present invention utilizes natural forces to promote the effective operation of the dispensing valve 100.

The actuator pin 182 is in continuous contact with the ball 260 on a side opposite contact by the biasing mechanism 250 with the ball 260. Thus, the actuator mechanism 140 is in the first “closed” position when the ball 260 is sealing port 139. Generally, the dispensing valve 100 remains in this first “closed” position. In this position, the actuator 160 urges the plunger member 166 outwardly towards the actuator end 103 of the valve body 101. The actuator 160 is in the first position when the disk 161 is at a first angle of incidence relative to the perpendicular plane of the axial direction of the plunger member 166 and the perpendicular plane of the stop 110 relative to the axial direction A of the dispensing valve 100. It is to be understood that the angles of incidences relative to the plunger member 166 and stop 110 may be the same or vary relative to one another in order to promote an increased effectiveness of operation and/or ease of use of the dispensing valve 100.

When the user desires to dispense fluid from the dispensing valve 100 connected with the container storing the fluid, the user may position the valve 100 into a second “open” position by depressing the button 141. For example, the user may grasp the grip wing 105 in one or more positions about the circumference of the wing 105 and then press a finger, such as a thumb, against the center of the button 141. The depressing of the button 141 moves the button from its first “closed” position into its second “open” position and results in a simultaneous movement of the actuator 160, plunger member 166, engagement pin 182, sealer (ball) 260 and biasing mechanism (spring) 250 into their respective second “open” positions. The open position is accomplished by moving the various features of the dispensing valve 100 in an opening direction (downwards or opposite the force F1) aligned with the axial direction A of the valve 100 and transverse to the axial direction B of the discharge channel 122. In this second position, the actuator 160 is deflected or biased along the axial direction A towards the first “inlet” end 102 of the valve body 101. The plunger member 166 is forced through the guide channel 117 of the guide member 112 and extends the engagement pin 182 towards the first end 102 and away from the second end 103 and bottom port 119 of the guide member 112 aligned with the actuator port 128 of the second section 120. As previously described the amount of deflection of the actuator 160 and travel of the plunger member 166 including the engagement pin 182 is determined by the stop (support ring ledge) 176 of the support ring 174 integral with the bottom 164 of the actuator 160 and outer wall 169 of the plunger member 166.

The travel of the engagement pin 182 into the second “open” position is further translated into a moving force exerted upon the sealer (ball) 260. As the engagement pin 182 is forced downwards along the axial direction A towards first end 102 it also forces the sealer (ball) 260 to move downwards in a similar direction. The force exerted by the engagement pin 182 is sufficient to overcome the biasing force F1 being exerted by the biasing mechanism (spring) 250 in an opposite direction along the axial direction A. As the sealer (ball) 260 is moved downwards the biasing mechanism (spring) 250 is forced to retract towards its engagement with the bottom cap 220 of the cage 202. The downward movement of the sealer (ball) 260 has the effect of displacing the ball 260 from its position relative to the port 238, valve port 139, and inlet port 126. The displacement of the ball 260 releases the fluid-tight seal and allows the fluid within the secondary valve body channel 31 and cage 202 to flow through these ports and into the discharge channel 122. This flow of fluid through the inlet port 126 into the discharge channel 122 allows the fluid to exit the dispensing valve 100 through the outlet port 124 of the discharge channel 122. The outlet port 124 is open to an environment external to the container and the dispensing valve wherein a user may have access to the fluid.

It is to be understood that as the user forces the plunger member 166 downwards (inward) or towards the first end 102 of the valve body 101 into the second “open” position, the resilient disk 161 of the actuator 160 is deflected, biased, or deformed. A closing or outward force (towards the actuator end 103 of the valve body 101) is applied by the resilient disk 161 and may rise as the plunger member 166 is displaced along the axial direction A in its movement towards the second “open” position. However, the closing force may not increase linearly with the inward displacement toward the open position. The closing force may first rise with the opening displacement from the closed position, then the increase in closing force per unit opening displacement may decline until the resilient disk 161 reaches a point of maximum closing force at an intermediate position, between the first position and second position, at which point the outward or closing force may begin to decline with increasing opening displacement.

The resilient disk 161 may exhibit a preferred maximum closing force (i.e., force exerted by resilient disk 161 that must be overcome in order to depress plunger member 113), such as two to two and a half pounds, at the intermediate position and then decline upon further opening displacement. The closing force exhibited may be based upon construction characteristics of the resilient disk 161. For instance, the two to two and a half pound closing force may be provided by a resilient disk having an outer perimeter 163 thickness of about twelve one-thousandths inch (0.012″) and about eighteen one-thousandths inch (0.018″) at its central connection with the plunger member 166. Alternatively, the resilient disk 161 may be provided a greater minimum average thickness of approximately 0.0155 inches, which may provide a larger maximum closing force of approximately three to three and a half pounds.

In another alternative embodiment, the resilient disk of the actuator is constructed of a polyethylene terephthalate (PET-C) and given an approximate minimum average thickness of 0.015 inches. The resilient disk requires an even greater force of approximately four to four and a half pounds. Further, the resilient disk may be constructed of the PET-C and given an approximate minimum average thickness of 0.0155 inches. This construction increases the force required to depress plunger member 113 to approximately five to five and a half pounds.

The use of various materials and thicknesses in the construction of the resilient disk 161 may determine the maximum force required during operation of the dispensing valve 100. It is further contemplated that regardless of the maximum forces achieved, that the minimum force reached by the resilient disk or the actuator required to hold the valve open remain approximately three quarters of a pound. By increasing the maximum force required, an increase in the snap-type closure effect of the actuator 160 as it moves from the open to the closed position may be achieved which may further promote a decrease in inadvertent operation of the dispensing valve 100.

The actuator 160 and plunger member 166 reach the second “open” position and have further movement arrested by the engagement of the stop 176 against the stop 116 of the guide member 112 before the outward or closing force exerted by the resilient disk 161 of the actuator 160 is negligible or unable to provide for the return of the resilient disk 161 to the second “closed” position. At this full open position of the dispensing valve 100, the force required to be applied by a user to maintain the open position is advantageously minimized. In a preferred embodiment, the force required is three-quarters pound. Alternatively, the force required may range from one-quarter pound to one pound without departing from the scope and spirit of the present invention.

The dome-shaped or conical resilient disk 161 may provide a non-linear spring characteristic with rising and falling force sections. The travel distance of the actuator 160 and plunger member 166 is set by the stop 176 engagement with stop 116 of the guide member 112 and may be determined to allow the full open position to be a position of decreased outward force as compared to the outward force experienced during travel from the closed position to the open position. It is contemplated that travel distances, such as one-tenth inch to one inch, or less than one-tenth inch and greater than one inch, may be constructed to promote the effective operation and the ease of operation of the dispensing valve 100.

The construction of the actuator mechanism to include such non-linear characteristics may provide several advantages. For instance, it may provide a substantial closing force at the first “closed” position, and hence promote an effective seal of the port 139, and a holding force at the second “open” position, which may be less than the force required to travel from the first to second position. Thus, maintaining the dispensing valve 100 in the second “open” position is promoted by requiring less force to hold it open than that experienced getting it open. The highest actuating forces of the resilient disk 161 are encountered only briefly and may promote a decrease in fatigue experienced by operation of the dispensing valve 100. Additionally, the non-linear characteristic may provide a desirable “feel” or tactile feedback, which confirms to the user that the dispensing valve 100 is open even if the user cannot see the flow of fluid or is not looking at the flow.

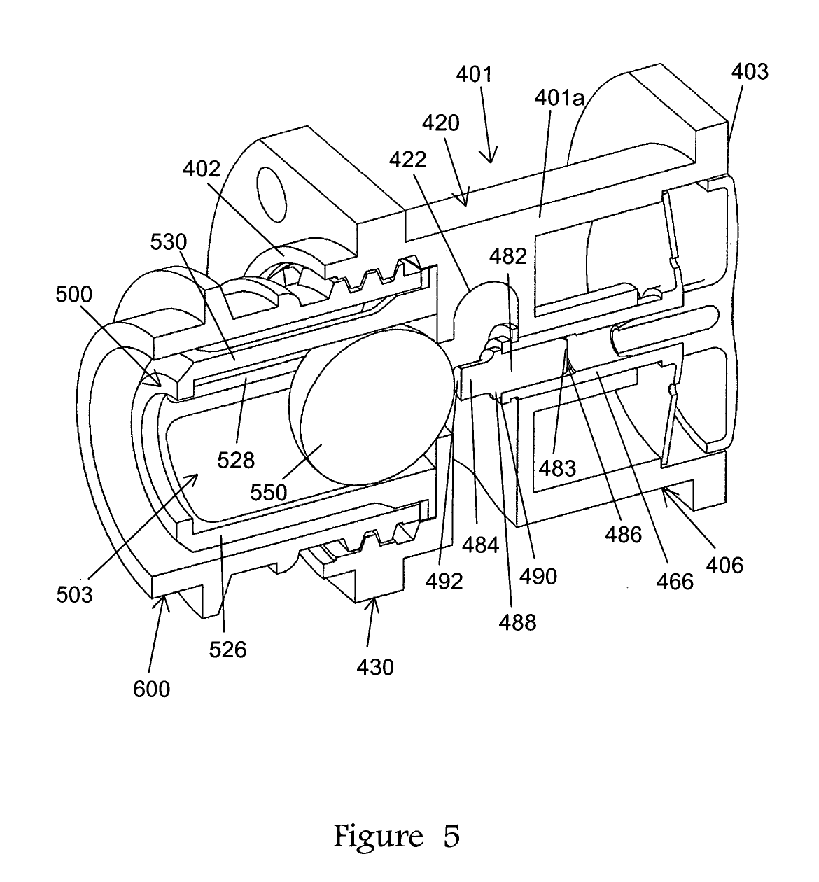

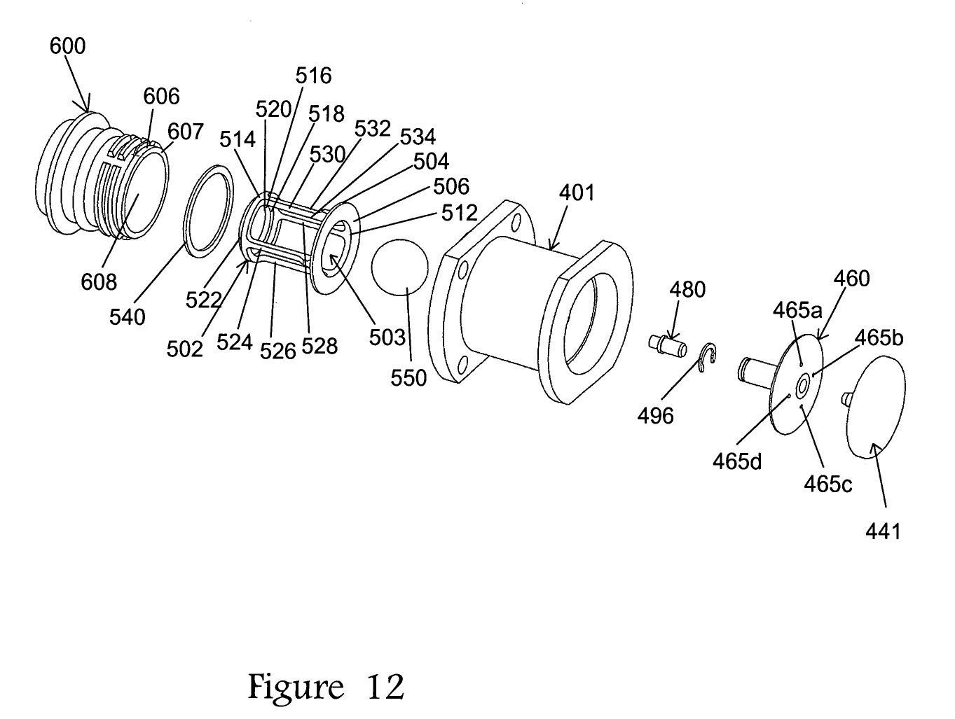

Referring now to FIGS. 5 through 12, a dispensing valve 400 that is similar in every respect to dispensing valve 100 except for the construction of the plunger member 466, actuator pin 482, and check assembly 500, is shown. In the current embodiment, a generally tubular valve body 401 including wall 401a is defined by a first “inlet” end 402 and a second “actuator” end 403. The valve body 401 is constructed of a first “top” section 406 integrally connected to a second “middle” section 420 which is further integrally connected to a third “bottom” section 430. The valve body 401 further connects with an actuator mechanism 440, a check assembly 500, and a secondary valve assembly 600, allowing the actuator mechanism 440 to operationally engage with the check assembly 500, which is further connected with the secondary valve assembly 600.

The plunger member 466 includes similar features as the plunger member 166, except bottom end 480 of the plunger member 466 includes a bottom port 481 which defines an opening in bottom end 480 and thusly, an open plunger member channel 468. In a preferred embodiment, the plunger member 466 has a length of approximately 0.617 inches and a diameter of approximately 0.220 inches. Alternative lengths and diameters and other dimensional characteristics may be employed as contemplated by those of ordinary skill in the art. A plunger member channel stop 473 is defined within the plunger member channel 468 between a top end 478 and the bottom end 480 of the plunger member 466 and plunger member channel 468. The stop 473 may promote the operation of the actuator pin 482 when received within the plunger member channel 468, as will be described below. It is to be understood that during operation of the dispensing valve 400 the plunger member 466 moves from a first “closed” position to a second “open” position in a similar manner as that described above for plunger member 166.

For dispensing valve 400, the actuator pin 482 is constructed to allow it to be removed from its connection within the plunger member channel 468. The actuator pin 482 includes a top side 483 that is received within the plunger member channel 468. The stop 473 may be contacted by the top side 483 of the actuator pin 482 when inserted within the plunger member channel 468. Thus, through engagement with top side 483 the stop 473 may provide support to the actuator pin 482 during operation of the dispensing valve 400. In a preferred embodiment, top side 483 includes a formed top edge 486, which may increase the effectiveness of the interaction between stop 473 and top side 483.

The actuator 482 includes a bottom side 484 including a striker 492 for contacting against and moving a sealer (ball) 550 of the check assembly 500. Disposed between the top side 483 and bottom side 484 is an actuator support ring 488 which provides an actuator stop 490. The actuator stop 490 is constructed to contact against the bottom end 480 of the plunger member 466. The stop 490 assists the operation of the dispensing valve 400 by providing structural reinforcement to the actuator pin 482 during operation of the dispensing valve 400. Thus, as the plunger member 466 is moved down, during an opening operation of the dispensing valve as described above for dispensing valve 100, stop 490 assists in the corresponding movement of the actuator pin 482 and avoiding unwanted movement of the actuator pin 482 when contacting against and moving the sealer (ball) 550.

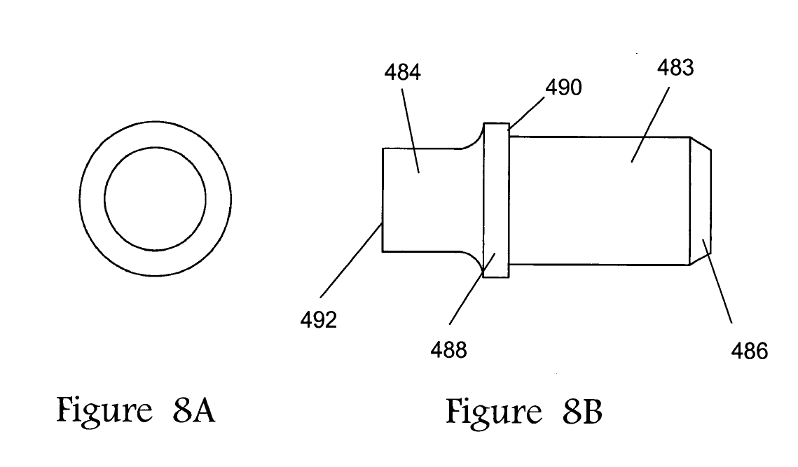

In a preferred embodiment, shown in FIGS. 8A and 8B, the actuator pin 482 has a length of approximately 0.406 inches. The bottom end 484 including the striker 492 provides a first diameter of approximately 0.13 inches and the top end 483 provides a second diameter of approximately 0.155 inches. Further, the support ring may have a width of approximately 0.03 inches and provide a third diameter of approximately 0.19 inches. It is contemplated that these and other various dimensional characteristics may vary as contemplated by those of ordinary skill in the art to promote the proper operation of dispensing valve 400 without departing from the scope and spirit of the present invention.

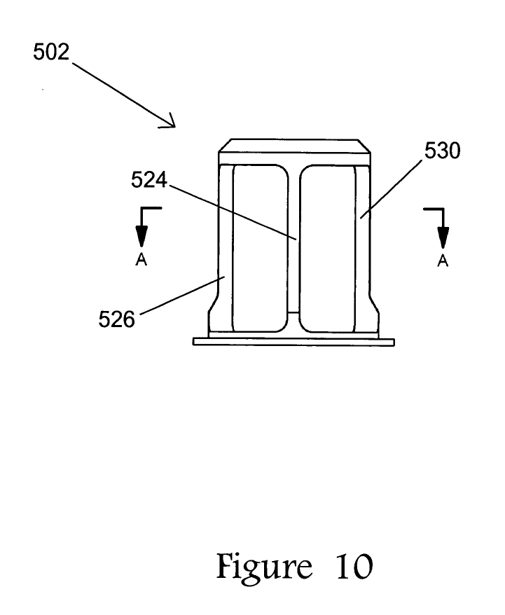

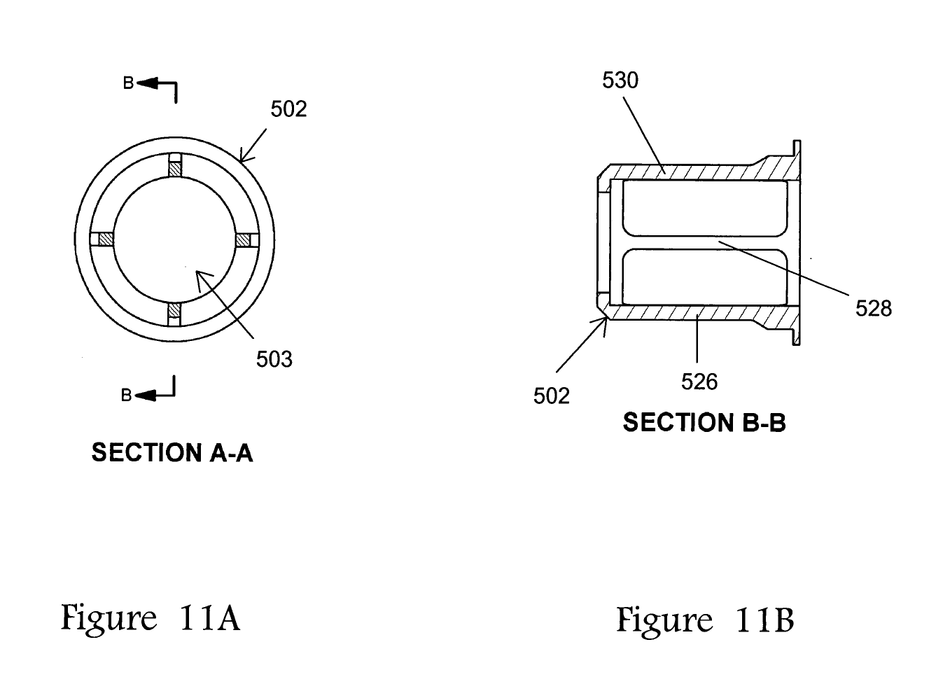

The check assembly 500 includes a cage 502 that provides a cage channel 503 within which the sealer (ball) 550 is received and operates to seal and release the ports that allow fluid into a discharge channel 422. FIGS. 10, 11A, and 11B depict a preferred embodiment of the cage 502. However, the cage 502 may be constructed with various alternative dimensional characteristics as contemplated by those of ordinary skill in the art to promote the proper operation of the dispensing valve 400. The cage 502 includes a first arm 524, a second arm 526, a third arm 528, and a fourth arm 530 each having inner and outer surfaces that are similar to those described above in reference to the cage 202. However, cage 502 utilizes a pressure from a fluid received within a secondary valve assembly 600 as the closing force for moving sealer (ball) 550 within the cage 502 and sealing the ports to the discharge channel 422. Thus, in the current embodiment, cage 502 does not provide a spring or other secondary device for providing the closing force against the sealer (ball) 550. Further, the four arms of the cage 502 are constructed to allow the proper operation of the sealer (ball) 550 utilizing the fluid pressure for providing the closing force in operation of the dispensing valve 400. In the current embodiment, the four arms of the cage 502 are constructed to provide a channel 503 defined by generally parallel arms with respect to the axial direction of movement of the sealer (ball) 550. It is contemplated that the arms may be variously constructed to allow the proper operation of the dispensing valve 400 without departing from the scope and spirit of the present invention. For example, the arms may be constructed with stops on their respective inner surfaces that contact against the sealer (ball) 550 and assist in preventing unwanted movement of the sealer (ball) 550 within the cage channel 503, which may further assist in the proper operation of the dispensing valve 400.

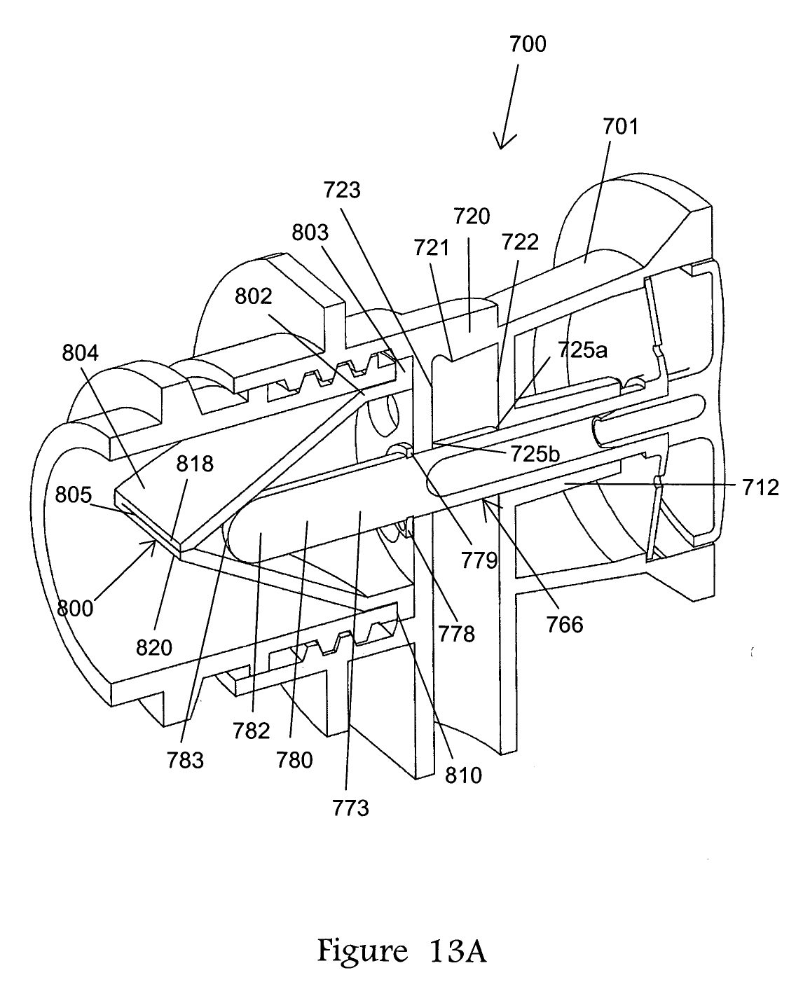

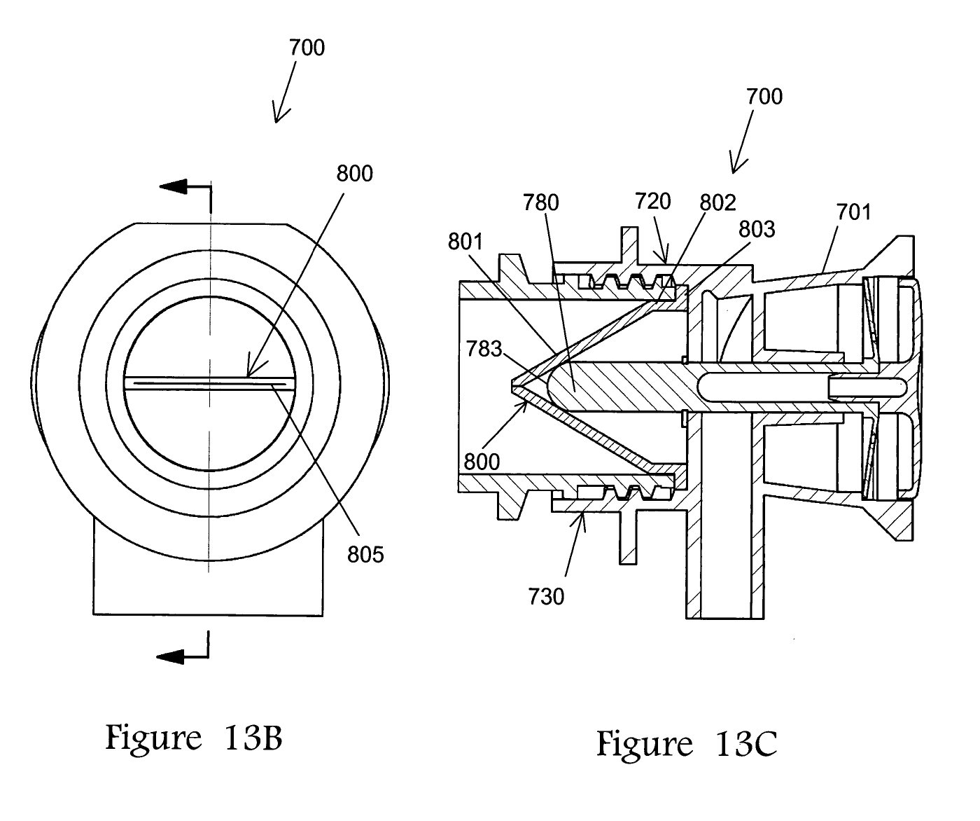

Referring generally now to FIGS. 13A through 16C, a dispensing valve 700 is shown and described. The dispensing valve 700 is similar in all respects to dispensing valve 100 except for modifications to a plunger member 766, a second “middle” section 720 and a check assembly 800, described herein. The second section 720 is constructed including a first actuator port 725a disposed within an upper wall 722 of a discharge channel 721 and a second actuator port 725b disposed within a bottom wall 723 of the discharge channel 721. The first and second actuator ports are constructed to allow plunger member 766 to extend through the first actuator port 725a, discharge channel 721 and second actuator port 725b. In operation, the movement of the plunger member 766 from a first “closed” position to a second “open” position involves a sliding movement of the plunger member 766 through a guide member 712 and the discharge channel 721 of the second section 720.

A third “bottom” section 730 includes a top wall 735 disposed with a port 735a which is operationally aligned with the second actuator port 725b of the second section 720. Port 735a allows the plunger member 766 to slidably move and extend/retract within a recessed area 804 of the check assembly 800. The top wall 735 further includes a first outlet port 736, second outlet port 737, third outlet port (not shown) and fourth outlet port (not shown). These four outlet ports are aligned through the top wall 735 with a first inlet port 724, second inlet port 726, third inlet port (not shown) and fourth inlet port (not shown) through the bottom wall 723 of the discharge channel 721. These aligned ports provide a plurality of through points that operationally connect the recessed area 804 with the discharge channel 721 and allow for the flow of fluid between the secondary valve body 901 and the valve body 701, allowing the fluid to pass through the discharge channel 721.

The plunger member 766 includes a retention device connector mechanism 778 disposed proximal to a bottom end 773 of the plunger member 766. However, instead of the retention device connector mechanism 778 being disposed between the upper and bottom walls of the discharge channel as it is for dispensing valve 100 and 400, retention device connector mechanism 778 is positioned within a recessed area 814 of the check assembly 800. The retention device connector mechanism 778 connects a retention device 779 with the plunger member 766. The positioning of the retention device 779 allows it to contact against the top wall 735 of the third section 730 to provide its functionality. An actuator pin 780 is integrally connected with the bottom end 773 of the plunger member 766. A bottom 782 of the actuator pin 780 includes a striker 783 that operatively interacts with the check assembly 800, described below.

The check assembly 800 includes a duckbill-shaped valve seal member 801 including a top end 802 integral with a ring 803 including a stop 810 and a bottom end 804 including a valve opening 805. In a preferred embodiment, the valve opening 805 is a lip shaped opening. The recessed area 814 is the area defined by an inner surface 807 of a wall 806 of the duckbill shaped valve seal member 801 and at either end by the top end 802 and the bottom end 804. It is contemplated that the dimensions of the duckbill shaped valve seal member 801 may be altered to accommodate its use with variously sized dispensing valve application or different fluid pressures. An outer surface 808 of wall 806 is in operational contact with a secondary valve body 901 of the secondary valve assembly 900, proximal to the top end 802. A stop 810 proximal to the top end 802 is utilized for providing a fluid tight, pressure fit connection between a secondary valve body 901 and the valve body 701. The use of various secondary valve seal rings or gaskets is contemplated to provide the fluid tight, pressure fit connection.

An advantage of the duckbill shaped valve is that these three-dimensional valves may allow free flow with a positive differential pressure while preventing flow with a negative differential pressure, thus backflow is checked. The materials used and construction specifications employed may allow the duckbill valve to provide for the flow of fluid at pre-determined pressures. The materials used to construct the duckbill shaped valve may be any resilient materials that will not react with or contaminate the fluid being dispensed, and which will not melt or degrade under the conditions encountered during manufacturing and use of the dispensing valve. For instance, various elastomers may include a thermoplastic or thermosetting elastomer, typically in the range of about 25 to 85 Shore A durometer. In a preferred embodiment, the duckbill shaped valve seal member 801 is constructed from a thermosetting rubber material. Alternatively, the duckbill shaped valve seal member 801 may be constructed from various other compounds, such as nitrile, hydrogenated nitrile, fluorosilicone, ethylene propylene, silicone, butyl, fluorocarbon, polyisoprene, epichlorohydrin, chloroprene, polyurethane, styrene-butadiene, polyacrylate acrylic, and the like which provide sufficient structural integrity and resiliency to allow the proper operation of the dispensing valve 700.

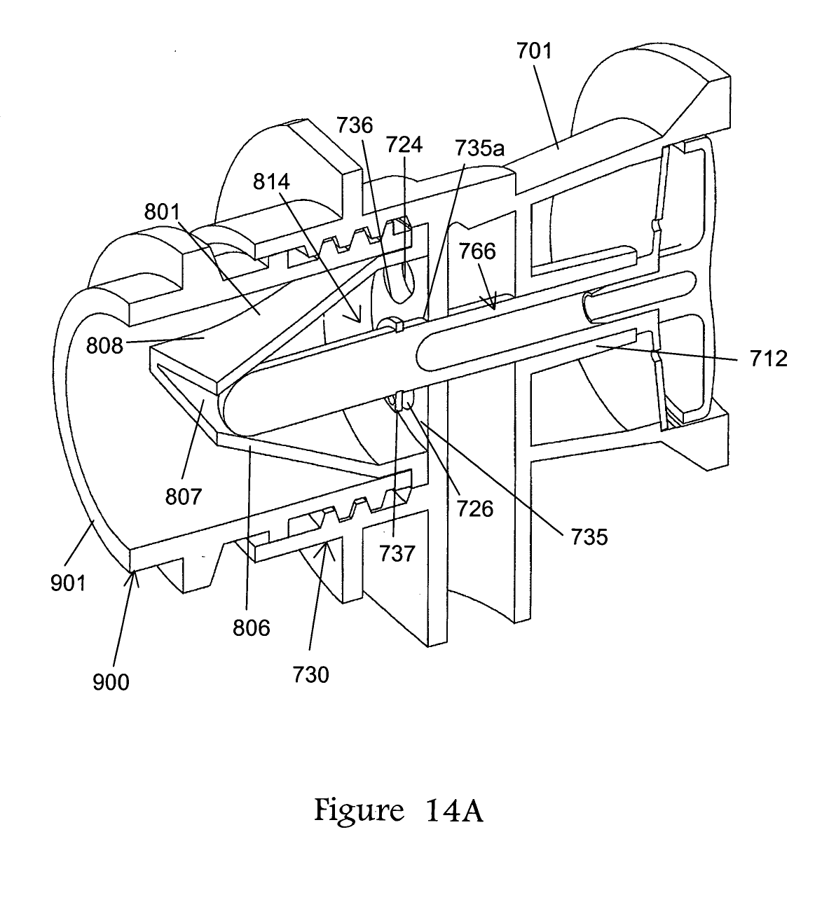

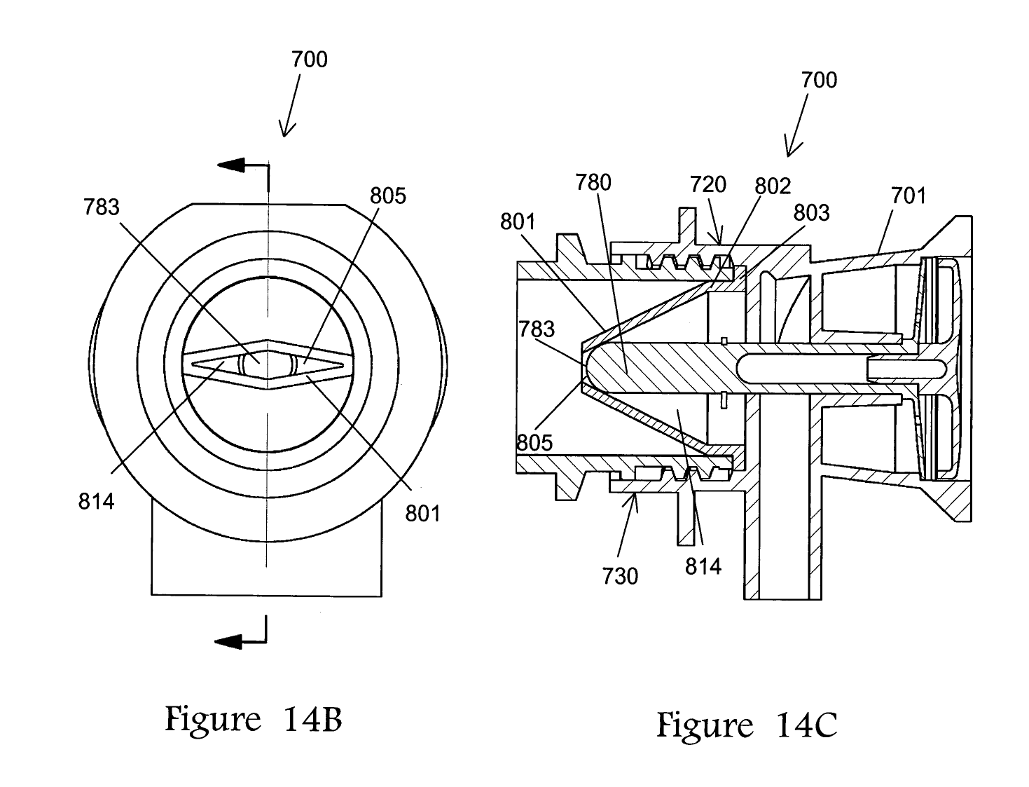

In a preferred embodiment, the plunger member 766 and duckbill shaped valve seal member 801 are initially positioned in the first “closed” position, as shown in FIG. 13. In this position, the valve seal member 801 may prevent the flow of fluid into the discharge channel 721. Similar to the operation described above in reference to dispensing valve 100, the plunger member 766 is slid downwards to open the valve seal member 801. As the plunger member 766 is slid down, it is extended further within the recessed area 814 until the striker 783 comes in contact with the inner surface 808 of the wall 806. As the plunger member 766 continues downward it causes the lip shaped opening 805 of the valve seal member 801 to open, as shown in FIG. 14, separating a first upper valve wall 818 and a lower valve wall 820, thereby allowing fluid to flow into the recessed area 814 and through the first through fourth outlet ports of the top wall 735 and first through fourth inlet ports of the bottom wall 723 of the second section 720 into the discharge channel 721. The dimensions of opening 805 may be determined by the dimensions of striker 783 and/or travel distance of the plunger member 766. For instance, the opening 805 may be defined by the size of the striker 783 if the second “open” position allows the striker 783 to pass through the opening 805 entirely. However, if the travel distance does not allow the striker 783 to pass entirely through the opening 805 then the opening 805 may establish an opening dimension, which is a ratio or percentage of the dimensional characteristics of the striker 783.

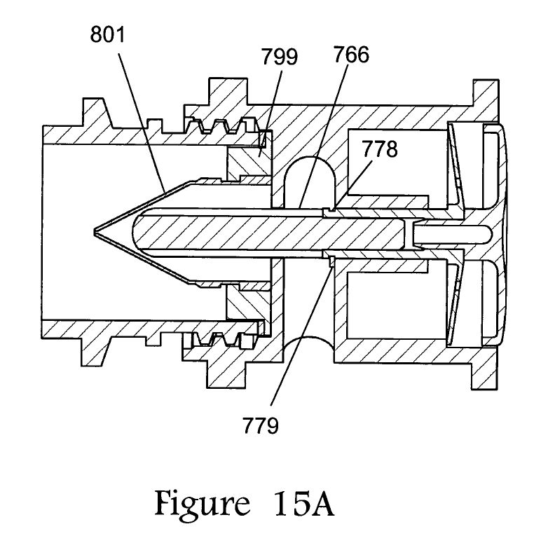

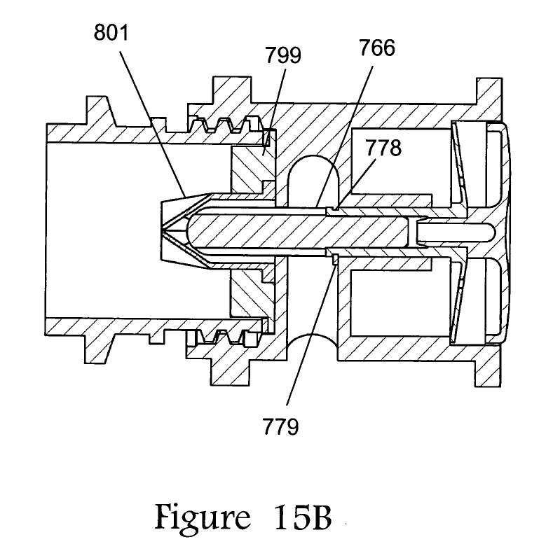

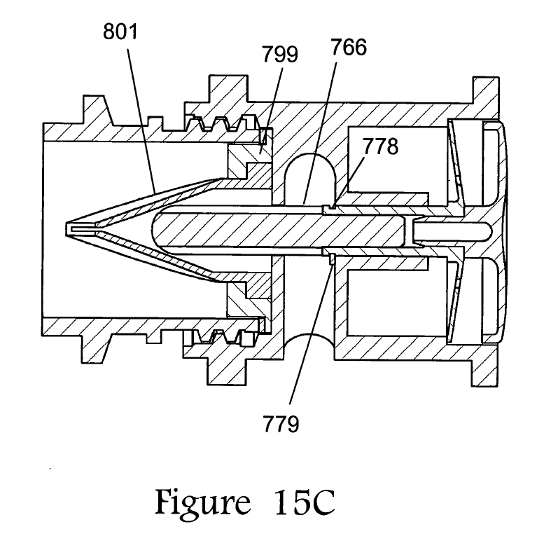

FIGS. 15A, 15B and 15C illustrate dispensing valves similar to dispensing valve 700 except that the retention device connecting mechanism has been positioned upon the plunger member between the top and bottom walls of the discharge channel and/or the duckbill shaped valve seal member's dimensional characteristics have been altered. FIG. 15A shows the dispensing valve 700 including a retention device connection mechanism located on the plunger member 766 in a position between the upper wall 722 and bottom wall 723 of the discharge channel 721. In FIG. 15B, the duckbill shaped valve seal member is constructed in a cruciform shape. Additionally, the upper and lower valve walls are constructed having approximately a twenty-degree displacement from the axial direction A of the dispensing valve 700. In FIG. 15C the upper and lower valve wall are constructed having approximately a ten-degree displacement from the axial direction A of the dispensing valve 700. Additionally, the bottom end 804 may be constructed to provide opening 805 with additional structural support. For example, the opening 805 may be reinforced by thickening the walls proximal to the opening 805. These various constructions of the duckbill shaped valve seal member may promote an optimal fluid flow rate during operation of the dispensing valve. Further, the different angular displacements may provide the opening of the duckbill shaped valve seal member with various fluid pressure sensitivity, thereby offering a more efficient and effective operation of the dispensing valve when employed with fluids under different pressures. For instance, the cruciform duckbill shaped valve seal member of FIG. 15B may provide a more optimal operating environment for the dispensing valve when dispensing fluids under increased pressures (i.e., >2ATM) than the duckbill shaped valve seal member of FIG. 15A or 15C. Alternatively, the duckbill shaped valve seal member of 15C may promote a more optimal operating environment for the dispensing valve when dispensing fluids under a pressure head provided by gravity.

The thickness of the wall 806 may promote the effectiveness of the duckbill shaped valve seal member when the dispensing valve is being used with fluids under different pressures. It is contemplated that the thickness of wall 806 may vary to accommodate these different pressure requirements, such that the wall 806 may provide a range of average minimum thicknesses between 0.01 inch and 0.1 inch. In the current embodiment, the wall 806 is constructed with a generally uniform thickness. It is further contemplated that the wall 806 may be constructed with different thicknesses being formed in different sections of the wall 806. Various construction techniques may be employed to provide this different thickness form. This difference in thickness may promote an increase in effectiveness of sensitivity to fluid pressure, deflective characteristics, flow rate, and various other characteristics of the duckbill valve seal member. For instance, the wall may generally increase in thickness from the opening 805 towards the top end 802 or from the top end 802 towards the opening 805.

It is further seen in FIGS. 15A, 15B and 15C that the connection of the duckbill shaped valve seal member with the valve body and secondary valve body may be accomplished utilizing a duckbill valve fit member 799. The duckbill valve fit member may provide a secondary device, similar to a seal ring, gasket, and the like, which on one end connects against the outer surface of the wall and on the opposite end connects with the secondary valve body against the valve body. The duckbill valve fit member may promote an effective coupling of the duckbill shaped valve seal member with the secondary valve body and valve body and further promote a fluid tight, pressure fit sealing about the outlet ports on the top wall of the third section of the valve body and the inlet ports on the bottom wall of the second section of the valve body. It is contemplated that the dimensional characteristics and point of contact between the duckbill valve fit member and the duckbill shaped valve seal member may vary to promote the effective coupling of the duckbill shaped valve seal member with the secondary valve body and the valve body.

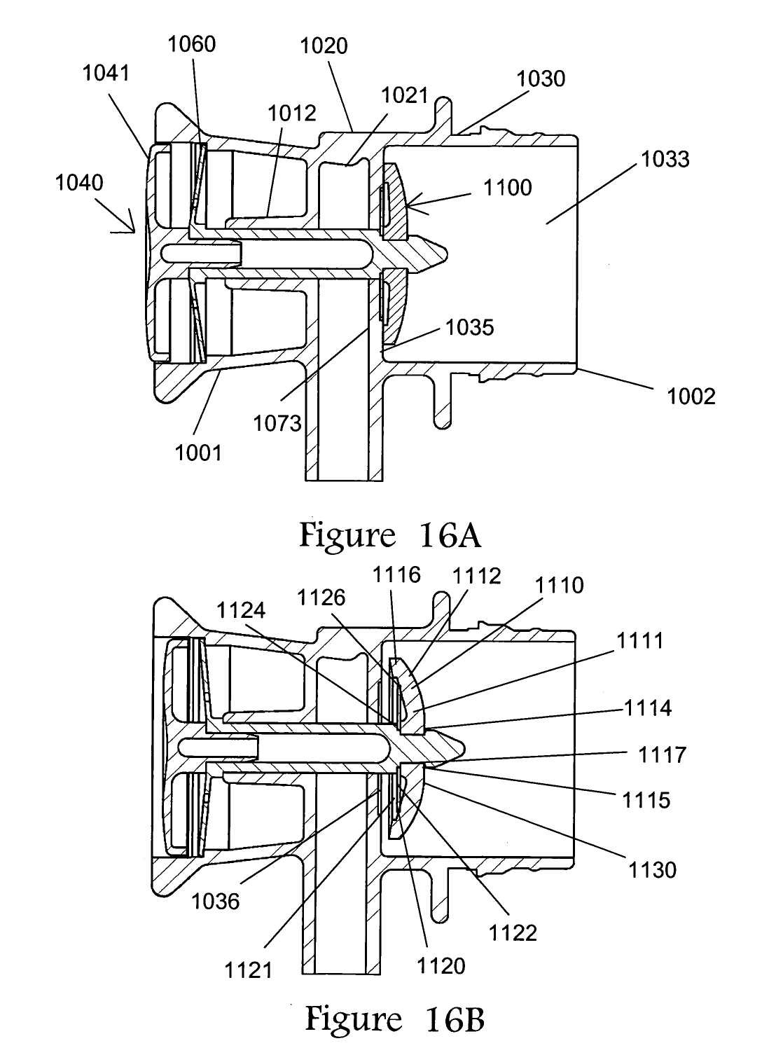

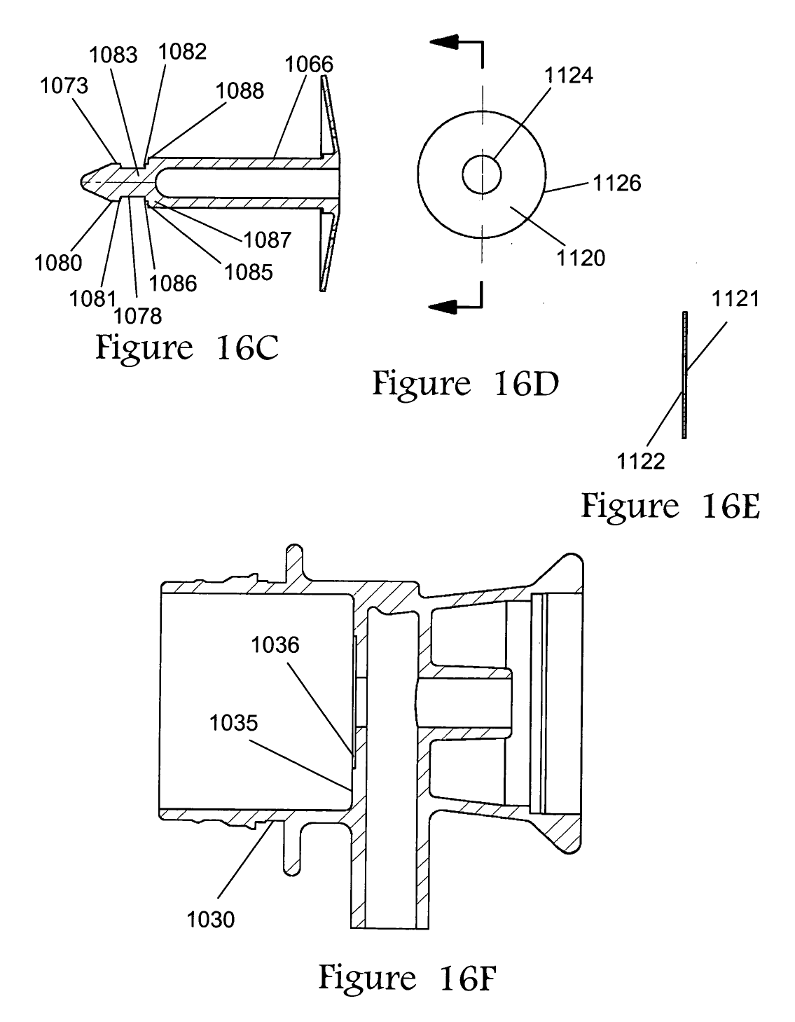

In accordance with yet another exemplary embodiment, a dispensing valve 1000 is shown in FIGS. 16A, 16B, 16C, 16D, 16E, and 16F. The dispensing valve 1000 is similar in every respect to the dispensing valves 100, 400 and 700 except for modifications to a plunger member 1066, second section bottom wall 1023, third section top wall 1035, and the check assembly 1100. The dispensing valve 1000 further differs from dispensing valves 100, 400 and 700 in that it may not utilize a secondary valve assembly as employed with the valves 100, 400 and 700. However, it is contemplated that a secondary valve assembly may be employed with dispensing valve 1000 without departing from the scope and spirit of the present invention.

The plunger member 1066 is slidably mounted in a guide member 1012 and connected with an actuator 1060 which is further connected with a button 1041 providing an actuator mechanism 1040 similar to the actuator mechanisms provided in the dispensing valves previously described. A bottom end 1073 of the plunger member 1066 extends through a second section 1020 and into a recessed area 1033 of a third section 1030 proximal to a first “inlet” end 1002 of a valve body 1001.

The check assembly 1100 includes a first valve seal 1110 including an outer surface 1111 and an inner surface 1112 and a second valve seal 1120 (boost washer) including an outer surface 1121 and an inner surface 1122. The first and second valve seals are disposed within the recessed area 1033 of the third section 1030 connected with the bottom end 1073 of the plunger member 1066. The second valve seal 1120 contacts with the first valve seal 1110 on the inner surface 1112 of the first valve seal 1110. The first valve seal 1110 includes an inner ring 1114 for connecting with the plunger member 1066 and an outer ring 1116 that defines a perimeter. In a preferred embodiment, the second valve seal 1120 includes an inner ring 1124, which connects with the plunger member 1066 and the inner ring 1114, and an outer ring end 1126 opposite the inner ring 1124, which contacts against the inner surface 1112 of the first valve seal 1110. The location of contact between the outer ring end 1126 and the inner surface 1112 may vary, but the outer ring end 1126 contacts along the inner surface 1112 somewhere between the inner ring 1114 and the outer ring 1116 of the first valve seal 1110.

In the current embodiment, the second end 1126 of the second valve seal 1120 contacts with the inner surface 1112 proximal to the outer ring 1116. The second valve seal 1120 is a generally planar member that extends from its connection with the plunger member 1066 and inner ring 1114 to the outer ring 1116. A recessed area 1130 is formed between the second valve seal 1120 and the first valve seal 1110. The recessed area 1130 may be of different sizes depending on the construction of the first and second valves or may be substantially eliminated.

The first and second valve seals are constructed and connected to provide a fluid tight, pressure fit about an outlet port 1036 disposed within the top wall 1035 of the third section 1030, which is operationally aligned, and form a fluid connection with an inlet port 1024 disposed within the bottom wall 1023 of the second section 1020. In a preferred embodiment, the number, shape, size and location of the outlet port(s) corresponds with the number, shape, size, and location of the inlet port(s) through the wall provided by the integral connection of the top wall 1035 with the bottom wall 1023. It is contemplated that the number, shape, size, and location of the outlet and inlet port (s) may vary to provide effective operation of the dispensing valve 1000. The fluid tight, pressure fit may be released and fluid allowed to flow through the outlet and inlet port(s) and out a discharge channel 1021 by user operation of the actuator mechanism 1040. The actuator mechanism 1040 allows a user to control the operation of the dispensing valve 1000 by selecting a first “closed” position, a second “open” position or alternative positions between the first and second positions, for the dispensing valve 1000.

The first and second valve seals may be formed from various resilient materials which do not react with or contaminate fluid being dispensed and may avoid melting or degrading under conditions encountered during manufacture or operation of the dispensing valve 1000. For example, the valve seals may be constructed of a thermoplastic or thermosetting elastomer or various other flexible, resilient materials having a range of approximately 30 to 80 Shore A durometer and more preferably ranging from 50 to 80 Shore A durometer. It is to be understood that these durometer ranges are exemplary of resilient materials typically employed in beverage (fluid) dispensing devices and that various materials having various resiliency factors, i.e., durometer factors greater than 80 Shore A durometer or less than 30 Shore A durometer, may be employed for use in the present invention. In a preferred embodiment, the first valve seal 1110 and second valve seal 1120 are constructed from a thermoplastic rubber.

The dimensional characteristics, such as diameter and thickness of the first and second valve seals may vary and may depend on the material used for construction of the valve seals and the operating conditions for the valve seals. For instance, when dispensing valve 1000 is being utilized for dispensing fluids under a gravity head (e.g., ranging from 0.5 to 1 pound per square inch pressure), the first valve seal 1110 may be approximately 1 inch in diameter and have an average minimum thickness of approximately 0.020 to 0.040 inches from its inner ring 1114 to the outer ring 1116 at its periphery. The second valve seal 1120 may be approximately 0.5 inches in diameter and have an average minimum thickness of approximately 0.005 to 0.020 inches from its first end 1124 to the second end 1126 at its periphery. Alternatively, if dispensing valve 1000 is being utilized for dispensing fluids under a pressure head greater than that of gravity the first valve seal 1110 may be approximately 1 inch in diameter and have an average minimum thickness of approximately 0.040 to 0.060 inches and the second valve seal 1120 may be approximately 0.5 inches in diameter and have an average minimum thickness of structural integrity that may be necessary when dispensing fluids contained under pressures other than gravity alone.

In the alternative, the first valve seal may be less than or greater than 1 inch in diameter with an average minimum thickness ranging from less than 0.020 inches to greater than 0.040 inches. The second valve seal 1120 may range from approximately 0.1 to 0.8 inches in diameter. Further, the second valve seal 1120 may be constructed with an average minimum thickness ranging from approximately 0.001 to 0.05 inches. It is contemplated that different diameter and thickness dimensions may be used to construct the first and second valve seals without departing from the scope and spirit of the present invention.

In a preferred embodiment, the first and second valve seal 1110 and 1120 are connected to the plunger member 1066 proximal to the bottom end 1073. The connection of the first valve seal 1110 with the bottom end 1073 of the plunger member 1066 is about a first valve seal receiver section 1078, which circumscribes the plunger member 1066. It is contemplated that various mechanical connection mechanisms may be employed to secure the connection of the first valve seal 1110 with the plunger member 1066 without departing from the scope and spirit of the present invention. The first valve seal receiver section 1078 is constructed for connection with an inner surface 1117 of a channel 1115 of the inner ring 1114 of the first valve seal 1110. The channel 1115 is generally disposed extending through the first valve seal 1110 at a mid-point or center. The channel 1115, via the inner surface 1117, defines a diameter or inner circumference that is constructed to be connected against the first valve seal receiver section 1078 after allowing the insertion of the bottom end 1073 of the plunger member 1066 through the channel 1115.

The first valve seal receiver section 1078 of the plunger member 1066 further includes a first valve seal receiver stop 1081 on a first end 1080 of the first valve seal receiver section 1078 and a second valve seal receiver stop 1083 on a second end 1082, opposite the first end 1080. The first stop 1081 connects against the outer surface 1111 of the first valve seal 1110 adjacent to the channel 1115 of the inner ring 1114. The second stop 1083 connects against the inner surface 1112 of the first valve seal 1110 adjacent to the channel 1115 of the inner ring 1114. The dimensional characteristics of the first and second stops may be varied to promote the secure connection of the first valve seal 1110 with the plunger member 1066 without departing from the scope and spirit of the present invention.

A second valve seal receiver section 1085 is disposed upon the plunger member 1066 proximal to the bottom end 1073 and adjacent the second valve seal receiver stop 1083 of the first valve receiver section 1078. In a preferred embodiment, the second valve seal receiver section 1085 has a width of approximately 0.015 inches. The second valve seal receiver section 1085 circumscribes the plunger member 1066 and is defined on a first end 1086 by the second valve seal receiver stop 1083 and on a second end 1087 by a second valve seal receiver stop 1088. In operation, an inner surface 1025 of a channel 1023 of the second valve seal 1120 seats against the second valve seal receiver section 1085 having the outer surface 1021 proximal to the first end 1024 contacting against the second valve seal receiver stop 1088 and the inner surface 1022 proximal to the first end 1024 contacting against the inner ring 1116 of the first valve seal 1110. Thus, the second valve seal 1120 is connected with the plunger member 1066 in a pressure fit manner.

It is contemplated that the first and second valve seal receiver sections may be variously constructed. For example, the dimensional characteristics, such as width, depth, length, and the like may be varied to promote the secure connection of the first and second valve seals with the plunger member 1066. It is further contemplated that various mechanical connection mechanisms may be employed to secure the connection of the second valve seal 1120 with the plunger member 1066 and first valve seal 1110 without departing from the scope and spirit of the present invention. For instance, the first and second valve seals may be connected with the plunger member 1066 by a threaded lock system, compression lock system, snap fit system, and the like as may be contemplated by those of ordinary skill in the art.

The port 1036 disposed within the top wall 1035 of the third section 1030 is constructed to receive the second valve seal 1120 which promotes the fluid tight, pressure fit sealing of the port when the dispensing valve 1000 is in the first “closed” position. Thus, the dimensional characteristics of the port 1036 within the top wall 1035 correspond at least partially with those of the second valve seal 1020. For instance, the length, width, and/or depth of the second valve seal 1020 may be constructed to ensure that it occupies the length, width, and/or depth of the port 1036. FIG. 16A shows the second valve seal 1120 received within port 1136 when dispensing valve 1000 is in the closed position. It is contemplated that the dimensional characteristics of both the port 1036 and the second valve seal 1120 may be varied to provide different flow rate characteristics, sealing force, and the like.

The present invention further contemplates a method of dispensing fluid from a container which stores the fluid under a pressure head equal to or greater than gravity. In a first exemplary step, a fluid being stored under a pressure within a container is selected. In a second step a dispensing valve, similar to the dispensing valves 100, 400, 700, and 1000, is connected with the container that stores the fluid under the specific pressure. For example, the dispensing valve may be connected to a container storing a carbonated beverage (i.e., soda pop). In a third step a user manually activates the dispensing valve to allow the flow of the fluid from within the container through the dispensing valve and to an environment outside the container and dispensing valve.

It is further contemplated that the method described above may further include the step of aligning a receptacle proximate to an outlet of the dispensing valve for receiving the dispensed fluid. Additionally, the method may include a step where the user releases their manual engagement with the dispensing valve, de-activating the dispensing valve, and thereby preventing the flow of fluid from within the container through the dispensing valve and to the outside environment.

A method of manufacturing a dispensing valve, similar to the dispensing valves 100, 400, 700 and 1000, is also contemplated by the present invention. In a first exemplary step, a material is selected for constructing the dispensing valve. The selection of material may be based upon various considerations, such as the ability of the dispensing valve to withstand vigorous sterilization techniques that may be required for use of the dispensing valve in food applications. These techniques may include irradiating the dispensing valve at up to 5.0 MRAD and subjecting the dispensing valve to high temperature chemical and steam sterilization processes. The material selected may be subjected to these and other types of techniques and processes and be required to be able to withstand them without causing the dispensing valve to lose structural integrity, such as becoming brittle, deformed, and the like, which may hinder or prevent the proper operation of the dispensing valve.

In a second step, the various components of the dispensing valve are constructed, such as the valve body, actuator mechanism, check assembly, and secondary valve body. Then in step the various components of the dispensing valve are assembled together to provide an operational dispensing valve. The assembly of the various components may occur through the use of several techniques known to those of ordinary skill in the art for the construction of the dispensing valve.

It is contemplated that the method may further include a sterilization step between the construction of the component features and the assembly of the components into the dispensing valve. As discussed above, the sterilization may include irradiation, chemical treatment, steam treatment, and various other techniques and processes. It is further contemplated that the sterilization step occurs during the construction of the component features, during the assembly of the component features or after the assembly of the components into an operational dispensing valve. The method of manufacture may also include the step of selecting material based on the material used for constructing the fluid container to which the dispensing valve may be connected.

The construction of the component features may include various steps for determining desired dimensional specifications for the various components and then constructing the components including those dimensions. For example, the component construction may include the step of determining the wall of the valve body to include a minimum average thickness of 0.0625 inches and the thickness of the wall formed between the first and second section of the valve body to be 0.025 inches. The next step is to construct these walls having these dimensional characteristics. Those of ordinary skill in the art, from the disclosure of the instant application, will understand that such variation may be determined and constructed for numerous dimensional aspects of the various component features of the present invention without departing from the scope and spirit of the present invention.

Still further, the method of manufacture may include the step of constructing a valve body of modular component features. For instance, the first section may be constructed separately from the second section, which may also be constructed separately from the third section. This modularity may be variously determined, such that any individual component feature may be separately constructed or constructed integral with any other component feature. The connection of the various component features may include the construction of various mechanical connection mechanisms into the component features, which allow for the mating and securing of the components with one another.

It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction, and arrangement of the components thereof without departing from the scope and spirit of the invention or without sacrificing all of its material advantages. The form herein before described being merely an explanatory embodiment thereof.

I claim:

1. A dispensing valve configured for dispensing fluids stored under pressure while maintaining a leak-free state between dispensing operations, comprising:
a first valve body having an actuator end and a fluid inlet end, a connector mechanism proximate said fluid inlet end, a fluid discharge outlet intermediate said actuator end and said fluid inlet end, and a fluid port allowing fluid communication between said fluid inlet end and said fluid discharge outlet;
a secondary valve body attached to said first valve body at said connector mechanism, said secondary valve body further comprising a one-way check assembly configured to selectively allow fluid to enter said fluid port and said discharge outlet, said one-way check assembly further comprising a resilient member biasing said check assembly towards a closed position in which fluid is prevented from entering said fluid port and said discharge outlet; and
a resilient actuator operatively connected to said one-way check assembly and operatively engaging said first valve body so as to move said one-way check assembly to an open position when said resilient actuator is engaged.

2. A dispensing valve configured for dispensing fluids stored under pressure while maintaining a leak-free state between dispensing operations, comprising:
a valve body having an actuator end and a fluid inlet end, a fluid discharge outlet intermediate said actuator end and said fluid inlet end, and a fluid port allowing fluid communication between said fluid inlet end and said fluid discharge outlet;
a one-way check assembly configured to selectively allow fluid to enter said fluid port and said discharge outlet, said one-way check assembly further comprising a resilient member biasing said check assembly towards a closed position in which fluid is prevented from entering said fluid port and said discharge outlet, said one-way check assembly being further biased towards a closed position by fluid stored within a container to which said dispensing valve is attached; and
a resilient actuator operatively connected to said one-way check assembly and operatively engaging said first valve body so as to move said one-way check assembly to an open position when said resilient actuator is engaged.
